(19) United States
(12) Patent Application Publication
(10) Pub. No.: US 2012/0294365 A1
(43) Pub. Date: Nov. 22, 2012

(54) IMAGE AND VIDEO ENCODING AND DECODING

(76) Inventors: Dong ZHENG, Ottawa (CA); Demin Wang, Ottawa (CA); Liang Zhang, Ottawa (CA)

(21) Appl. No.: 13/435,148

(22) Filed: Mar. 30, 2012

Related U.S. Application Data
(60) Provisional application No. 61/487,000, filed on May 17, 2011.

(51) Int. Cl. H04N 7/34; G06K 9/36; H04N 7/26

(52) U.S. Cl. 375/240.16; 375/240.24; 375/240.2; 382/238; 382/250; 375/E07.104; 375/E07.243

(57) ABSTRACT

A method and system for image and video encoding and decoding is disclosed. A plurality of macro-blocks of pixels are defined in the image to be encoded, for subsequent block-by-block encoding and decoding. A node-cell structure of pixels is individually defined for each macro-block. The node pixels are encoded first. Then, the cell pixels are encoded using the decoded node pixels as a reference. This allows increasing macro-block size without a significant degradation of pixel encoding quality.

### CROSS-REFERENCE TO RELATED APPLICATIONS

The present invention claims priority from U.S. provisional patent application No. 61/487,000, filed May 17, 2011, which is incorporated herein by reference.

### TECHNICAL FIELD

The present invention relates to image processing, and in particular to systems and methods for image and video encoding and decoding, for example for transmission and/or storage.

### BACKGROUND OF THE INVENTION

High-definition television broadcasting and video communications are becoming more and more common. Efficient compression of high definition digital image and video content is essential for its efficient transmission and storage.

A number of standards have been developed for video and image compression. A recent video coding standard MPEG-4 AVC covers a wide spectrum of video applications, from low bit rate and low resolution mobile video to Digital Video Disk (DVD) and High Definition Television (HDTV) broadcasting. With regards to image compression, JPEG-2000 is presently a latest image compression standard, which supersedes a previous JPEG standard. JPEG-2000 uses wavelet transform and advanced entropy encoding techniques to provide the bit rate-distortion performance improvement over the previous JPEG standard.

Video frames often have areas that correlate to each other. A video can be compressed by taking advantage of such correlations. Typically, this is done by providing a reference to a similar portion of a previous video frame, instead of encoding the present video frame in its entirety. Such video compression technique is referred to as “inter-frame coding”. Correlations may also be present within a single video frame, or within a single still image. By way of example, pixels of a uniform background of an image, having similar luminosity and color, may be efficiently encoded by interpolating or averaging the pixel luminosity and color across the background part of the image. Video and image compression techniques utilizing such correlations are termed “intra-frame coding”. For certain applications, intra-frame only coding is preferable to intra and inter-frame hybrid coding, because it offers a lower video latency and a better error resilience upon reception and/or readout from a storage device. Intra-frame only coding also simplifies video editing, making it more flexible and straightforward.

Referring to FIGS. 1A and 1B, an example of a prior-art intra-frame coding process 140 for encoding a video frame 100 is presented. In a step 141 of the process 140, the video frame 100 is divided into “intra-prediction” blocks 101 . . . 112, which are encoded one after another. In a step 142, pixels of the first block 101 are “predicted” using pixel values of top boundary one-pixel row 121, left boundary one-pixel column 125, and top-right boundary one-pixel row 122. In a step 143, “residuals”, that is, differences between the actual and “predicted” pixel values, are encoded using a spatial Fourier-like transform, such as Discrete Cosine Transform (DCT), together with quantization and entropy coding. In a step 144, all pixel values of the block 101 including the right-side and bottom-side boundary pixel rows 131 and 132, respectively, are “reconstructed”, that is, a reverse calculation of the pixel values is performed. In a step 145, the second block 102 is selected for processing. The right-side “reconstructed” boundary pixels 131, a next top boundary one-pixel row 122 and top-right boundary one-pixel row 123 will be used for “prediction” of the second block 102. The coding process 140 repeats for the remaining blocks 103 . . . 112, until all pixels of the video frame 100 are encoded. The encoding parameters for each block 101 . . . 112 are transmitted to a receiver location, where the frame 101 is reconstructed using a reverse computation. Taken together, all encoding parameters require a smaller transmission or storage capacity than all the pixels of the frame 100. This is because the amplitude of the “residuals” is typically much smaller than the amplitude of actual pixel luminosity and color, thus requiring less bits to store and transmit the residuals amplitudes. A spatial transform, such as DCT, helps to further reduce the number of bits required to store and transmit the frame 100.

Recently, Joint Collaborative Team on Video Coding (JCT-VC) has attempted to improve efficiency of encoding of high-definition video frames by increasing the size of the intra-prediction blocks in MPEG-4 AVC. This simple modification of the MPEG-4 AVC standard is disclosed in “Draft Test Model under Consideration”, JCTVC-B205, 2nd JCT-VC Meeting, Geneva, CH, July 2010. It has been found, however, that pixel “prediction” techniques do not work very efficiently at the increased size of the coding blocks. The farther away are pixels of the current intra-prediction block from the neighboring encoded blocks, the less correlation those pixels may have with the pixels in the neighboring encoded blocks, which increases the prediction error.

D. Marpe et al. in “Video Compression Using Nested Quadtree Structures, Leaf Merging and Improved Techniques for Motion Representation and Entropy Coding,” IEEE Transactions on Circuits and Systems for Video Technology, vol. 20, no. 12, pp. 1676-1687, December 2010, disclosed a quadtree structure of coding blocks, which can efficiently provide multi-level macro-block sub-division, using progressively smaller and smaller sub-block sizes for more accurate prediction for high-definition imagery. While smaller sub-blocks can address the problem of inefficient intra-prediction, the improvement is achieved at an account of increasing the overhead bit usage and computation complexity.

In addition to larger macro-blocks, large-size DCT such as 8×8 and 16×16 DCT was proposed by Dong et al. in “2-D Order-16 Integer Transforms for HD Video Coding,” IEEE Transactions on Circuits and Systems for Video Technology, vol. 19, no. 10, pp. 1462-1474, October 2009, and by Ma et al. in, “High definition video coding with super-macroblocks,” Visual Communications and Image Processing (VCIP) in the IS&T/SPIE Symposium on Electronic Imaging, San Jose, Calif., USA, Jan. 28-Feb. 1, 2007. Detrimentally, larger-size DCT can be prohibitively computation-intensive for many practical systems.

High-definition video transmission requires much more bandwidth in comparison with requirements for a standard-definition video. This strongly impedes initial deployment of high-definition video services. To address the problem of initial deployment, the techniques of “scalable video coding” and “super-resolution” have been proposed to encode high-definition video content for transmission at different bit rates. By way of example, Bernardus et al. in U.S. Pat. No. 7,359,558 disclose a video stream is down-sampled and encoded as the base stream. The base stream is decoded and spatially up-converted using up-sampling and spatial interpolation algorithms. The difference between the up-converted video and the original video is encoded as an additional stream termed “enhancement stream”. During decoding, the base stream and the enhancement stream are decoded and combined together to produce the high-resolution video output. As a result, the quality of the transmitted video signal can be made scalable with the available bandwidth. When little bandwidth is available, only the base stream is transmitted, and the quality of video is comparatively low. As more bandwidth becomes available, more and more high-definition video frames are transmitted in the enhancement stream, resulting in a more detailed video picture.

Garrido et al. in U.S. Pat. No. 7,656,950 discloses an example-based super-resolution technique. A set of block residual patterns are defined through a “training” process. The reconstructed base stream is up-scaled using predictive interpolation, and the predictive interpolation error is classified as one of the predefined patterns, and the classified pattern is encoded as the enhancement stream. The decoder applies this classified pattern to the up-scaled base stream to generate the high resolution enhancement stream.

The “scalable video coding” and “super-resolution” techniques of Bernardus et al. and Garrido et al. employ a fixed down-sampling rate for every block of a frame and every frame of a video. Detrimentally, a uniform down-sample rate across the whole frame, and from one frame to another, may not be optimal for video frames having a varying degree of details.

The prior art, although providing many techniques for video transmission and storage of standard-definition video, is still lacking a technique for efficient compression of a high-definition image and video content, without a considerable degradation of image quality.

### SUMMARY OF THE INVENTION

It is an objective of the invention is to provide coding methods and systems for efficiently compressing high definition images and video content.

In the present invention, a plurality of macro-blocks of pixels are defined in the image to be encoded, for subsequent block-by-block encoding. A node-cell structure of pixels is defined for each macro-block. The node pixels are encoded first. Then, the cell pixels are encoded using the decoded node pixels as a reference. Boundary pixels of neighboring macro-blocks can also be used as a reference for encoding. Since every cell pixel has some node pixels nearby, the efficiency and accuracy of cell pixel encoding is greatly improved. In one embodiment, the cell pixels are interpolated between the node pixels, and the differences between the interpolated and the original values of the cell pixels, herein termed as “residuals”, are further encoded using a Discrete Cosine Transform (DCT) or any other spatial transform-based coding method, including Wavelet Transform (WT). Also in one embodiment, DCT/WT is followed by the quantization of the transform coefficients.

In accordance with the invention there is provided a method for encoding an image, implemented at least in part by a computing device, the method comprising:

(a) defining in the image a plurality of macro-blocks of pixels, for subsequent block-by-block encoding; and
(b) for at least a first macro-block of the plurality of macro-blocks of step (a),
(i) defining a portion of pixels of the first macro-block as node pixels, and defining the remaining pixels of the first macro-block as cell pixels, wherein the node pixels are disposed in a pre-defined pattern of pixels;
(ii) encoding values of the node pixels of the first macro-block as node pixel information;
(iii) reconstructing the values of the node pixels from the node pixel information of step (b)(ii); and
(iv) encoding values of the cell pixels of the first macro-block as cell pixel information, using the reconstructed values of step (b)(iii).

The above process can be repeated for each remaining macro-block of the image. The “encoding” can include DCT, quantization, and/or entropy coding. Since the cell pixel values are encoded based on reconstructed node pixel values, the quantization step for node pixels can be made smaller than the quantization step for cell pixels of the macro-block.

After the encoded image has been received at the destination or read out from the digital storage medium, decoding is performed. For each encoded macro-block of the image, the decoding is performed in two steps. First, values of the node pixels of the macro-block are reconstructed. Second, values of the cell pixels of the first macro-block are reconstructed using the reconstructed values of the node pixels of the macro-block. The node pixels thus serve as “reference points” for improving efficiency of encoding and decoding.

In one embodiment, in step (b)(i), the node pixels comprise a 2M×2N rectangular array of pixels, including first and second M×N interleaved rectangular sub-arrays of pixels, wherein M, N are integers≧2. Pixels of any row of the first sub-array are interleaved with pixels of a corresponding row of the second sub-array. In this embodiment, the node pixel encoding is performed in three steps. First, values the node pixels of the first sub-array are encoded as first sub-array node pixel information. Second, the node pixel values of the first sub-array are reconstructed from the first sub-array node pixel information. Third, the node pixel values of the second sub-array are encoded as second sub-array node pixel information, using the reconstructed values of the node pixel values of the first sub-array. This process, termed herein “interleaved encoding”, can continue for third and fourth interleaved sub-array of node pixels. The interleaved encoding can be combined with DCT to further improve the compression efficiency.

In accordance with another aspect of the invention, step (b) is repeated at a plurality of “coding modes”, each coding mode including a pre-defined pattern of a plurality of pre-defined patterns of the node pixels, and encoding parameters for encoding the node and the cell pixels. Step (b) further includes calculating a rate-distortion optimization parameter of the first macro-block. The rate-distortion parameter is based on differences between original and reconstructed values of pixels of the first macro-block, and on a value for a number of bits needed to encode the pixels of the first macro-block. Upon repeating step (b) for each of the plurality of coding modes, a coding mode is selected that corresponds to the lowest of the calculated rate-distortion parameters.

The rate-distortion optimization can include not only coding methods of the invention, but also known coding methods of MPEG-4 AVC or JPEG-2000 standards. Thus, the encoding system can select a coding method most suitable for the particular macro-block of a frame being encoded.

In accordance with the invention, there is further provided a system for compressing an image, comprising:

a unit configured for defining in the image a plurality of macro-blocks of pixels, for subsequent block-by-block encoding; and
a macro-block processor suitably configured for encoding at least a first macro-block of the plurality of macro-blocks by
(i) defining a portion of pixels of the first macro-block as node pixels, and defining the remaining pixels of the first macro-block as cell pixels, wherein the node pixels are disposed in a pre-defined pattern of pixels;
(ii) encoding values of the node pixels of the first macro-block as node pixel information;
(iii) reconstructing values of the node pixels from the node pixel information; and
(iv) encoding values of the cell pixels of the first macro-block as cell pixel information, using the reconstructed values of the node pixels.

The present invention can be used for High-Definition Television (HDTV) transmission, and for general high-definition video or image transmission, storage, broadcasting, streaming, and the like.

The present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. The computer readable medium can be distributed among computer systems that are interconnected through a network, and the present invention may be stored and implemented as computer readable code in the distributed system.

### BRIEF DESCRIPTION OF THE DRAWINGS

Exemplary embodiments will now be described in conjunction with the drawings, in which:

FIG. 1A is a diagram of a prior-art video frame divided into blocks;

FIG. 1B is a block diagram of a prior-art method of compression of the video frame of FIG. 1A;

FIG. 2A is a diagram of a video frame divided into macro-blocks having defined therein node and cell pixels according to the invention, each macro-block having four node pixels;

FIG. 2B is a block diagram of a method for compression of the video frame according to the invention, for compressing the video frame of FIG. 2A;

FIG. 3 is a block diagram of encoding node pixels of FIG. 2A;

FIG. 4A is view of a sub-block including one node pixel and fifteen cell pixels, and four node pixels near the sub-block, for interpolation of cell pixel values;

FIG. 4B is a block diagram of a method for a non-directional interpolation of values of the cell pixels of FIG. 4A;

FIG. 4C is a block diagram of a method for a directional interpolation of values of the cell pixels of FIG. 4A;

FIG. 4D is a block diagram of a method of the directional interpolation of FIG. 4C, further including computation and propagation of residuals of bilinear interpolation of boundary pixels near the sub-block;

FIGS. 5A to 5C are examples of node pixel patterns of macro-blocks, having evenly (FIG. 5A) and unevenly spaced (FIGS. 5B, 5C) 4×4 arrays of node pixels;

FIG. 6A is a view of a macro-block having a 8×8 array of node pixels including four interleaved 4×4 sub-arrays of node pixels according to the invention;

FIG. 6B is a diagram illustrating the order of encoding/decoding the four 4×4 sub-arrays of node pixels of FIG. 6A;

FIG. 7A is a view of a macro-block having a 8×8 array of unevenly spaced node pixels including four interleaved 4×4 sub-arrays of node pixels;

FIG. 7B is a diagram illustrating the order of encoding/decoding the 4×4 sub-arrays of the unevenly spaced node pixels of FIG. 7A;

FIG. 8 is a block diagram of encoding 8×8 node pixels of FIGS. 6A and 7A;

FIGS. 9A and 9B are views of a macro-block having a 16×16 array of node pixels;

FIG. 10 is a block diagram of a method for encoding 16×16 node pixels of FIGS. 9A and 9B;

FIG. 11 is a view of the sub-block of pixels, having the pixels denoted with small cap and large cap English letters;

FIG. 12 is a diagram showing first to eighth numbered directions for directional interpolation using reconstructed node pixel values of FIG. 11, according to the invention;

FIGS. 13A to 13H are diagrams showing the directions of the directional interpolation for the first to the eighth directions, respectively, of FIG. 12;

FIG. 14A is a pixel diagram indicating directions of one-dimensional 4-pixel Discrete Cosine Transform (DCT) for cell pixels of a sub-block having one node pixel and fifteen cell pixels;

FIG. 14B is a pixel diagram indicating directions of one-dimensional 4-pixel Discrete Cosine Transform (DCT) for cell pixels of a sub-block having four node pixels and twelve cell pixels;

FIG. 15 is a block diagram of a method for cell pixel encoding using a sequence of one-dimensional (1-D) DCT transforms in place of a two-dimensional (2-D) DCT transform;

FIG. 16 is a two-dimensional plot of a quantization parameter for cell pixels, Qc, as a function of a quantization parameter for node pixels, Qn, for an optimized rate-distortion parameter;

FIG. 17 is a block diagram of an image encoding method of the invention including coding mode optimization;

FIGS. 18A and 18B are block diagrams of block-by-block coding mode selection among coding methods of the invention and known coding methods, for intra-frame and inter-frame encoding, respectively; and

FIGS. 19 to 23 are experimental plots of signal-to-noise ratio vs. bit usage for the “Portents”, “String”, “Kimono”, “Parkscene”, and “Train” standard test videos, respectively.

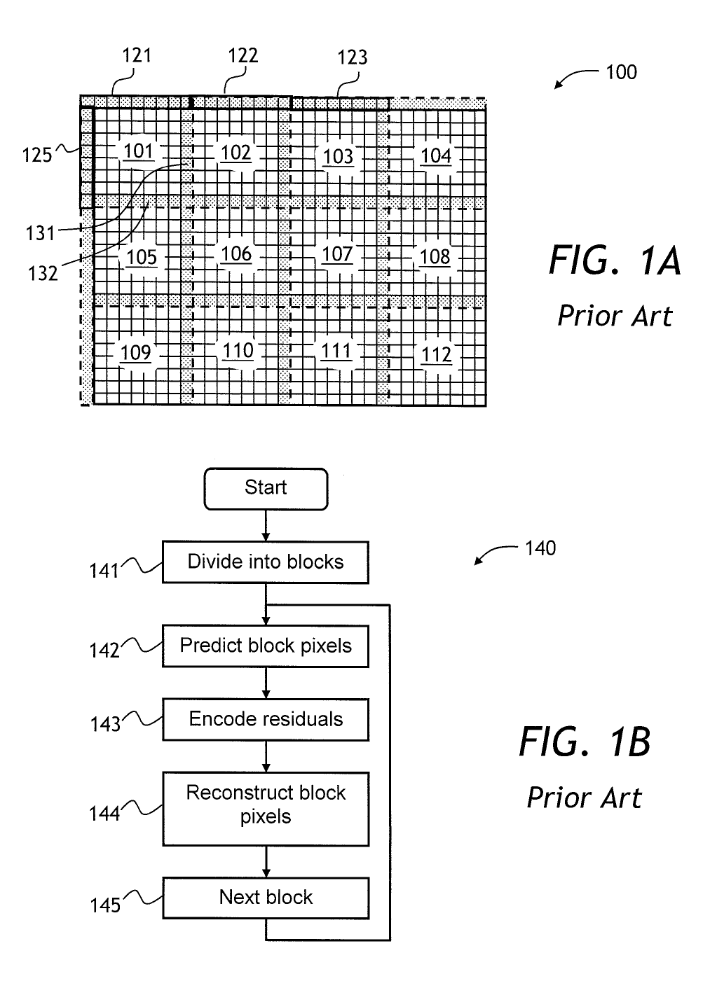

### DETAILED DESCRIPTION OF THE INVENTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

According to the invention, an image or a video frame is encoded by defining a node-pixel structure within the image or the video frame, encoding node pixels, and encoding cell pixels using decoded node pixels as a reference. Boundary pixels of neighboring macro-blocks may also be used as a reference for the encoding. A general node-cell pixel structure of the invention and an encoding based on the node-cell pixel structure will be considered first. Then, detailed disclosures of node and cell pixel encoding methods of the invention will be provided. Finally, a rate-distortion optimization method of the invention will be described, along with experimental results.

Node-Cell Pixel Structure and Encoding Based Thereon

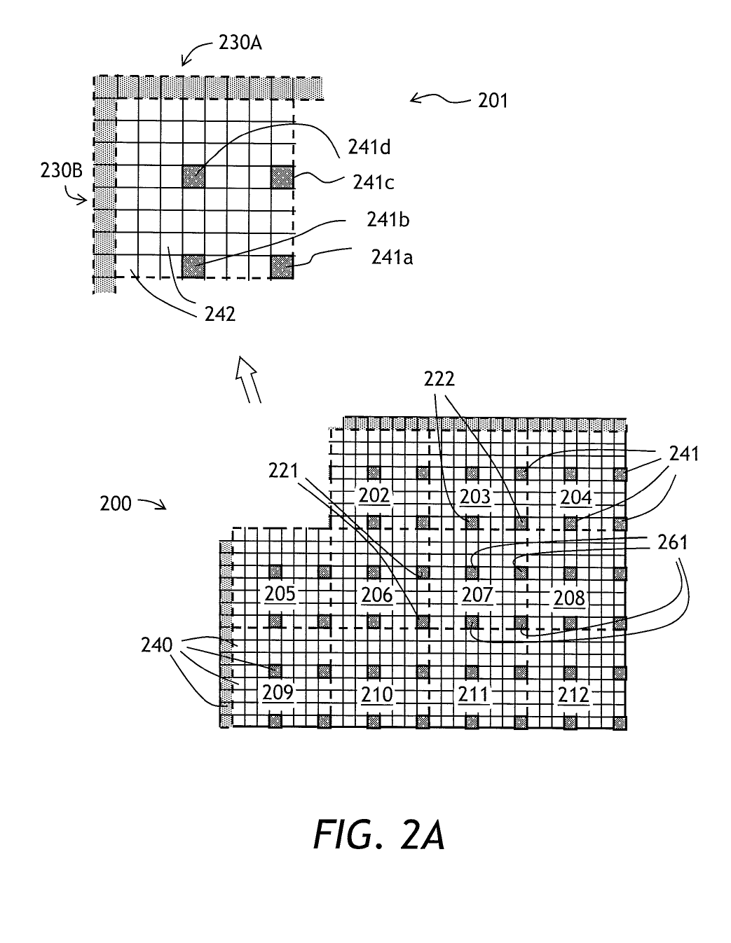

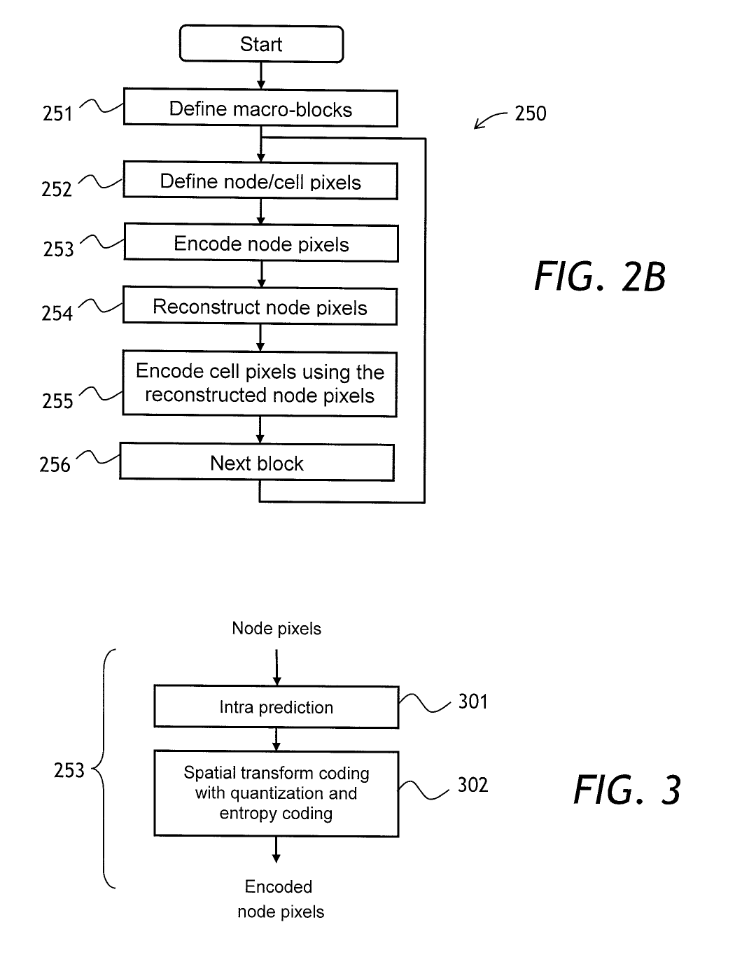

Referring to FIGS. 2A and 2B, a method 250 of encoding an image 200 is presented. The image 200, shown in FIG. 2A, has a two-dimensional array of pixels 240. The pixels 240 are shown as small white, dashed, or dotted squares. In a step 251 of the method 250 illustrated in FIG. 2B, macro-blocks 201 . . . 212 are defined in the image 200 for subsequent block-by-block encoding of the image 200. The boundaries of the macro-blocks 201 . . . 212 are shown in FIG. 2A in thick dashed lines. The first macro-block 201 is shown in FIG. 2A in a cut-out form.

Encoding of the macro-blocks 201 . . . 212 will now be described using encoding of the first macro-block 201 as an example. In a step 252, a portion of pixels of the first macro-block 201 is defined as “node pixels” 241a . . . 241d, shown in FIG. 2A as dark rectangles with white dots. The remaining pixels of the first macro-block 201 are defined as “cell pixels” 242. The cell pixels 242 are shown as white rectangles. The node pixels 241a . . . 241d are disposed in a pre-defined pattern of pixels, for example a square pattern as shown. In a step 253, values of the node pixels 241a . . . 241d, such as luminosity, color coordinates, etc., are encoded. Herein, the term “encoded” means represented by a set of parameters which, when used in a pre-defined computation corresponding to a coding mode, allow a subsequent “reconstruction” of the encoded values of the node pixels 241a . . . 241d. This set of parameters is termed herein as “node pixel information”. The reconstructed values are not necessarily equal to the actual values, but they can closely approximate the actual values. When performed for all node pixels 241a . . . 241d of the macro-block 201, the encoding allows to represent values of the node pixels 241a . . . 241d with the node pixel information requiring fewer bits for transmission or storage than the actual values of the node pixels 241a . . . 241d themselves, thus achieving “compression”. The details of encoding of the node pixels 241a . . . 241d will be given further below.

In a step 254, the values of the node pixels 241a . . . 241d are reconstructed from the node pixel information. Then, in a step 255, values of the cell pixels 242 are encoded as “cell pixel information”, using the reconstructed values of the node pixels 241a . . . 241d. Values of boundary pixels 230A, B can also be used for encoding the cell pixels. The details of encoding of the cell pixels 242 will also be given further below.

In a step 256, a next macro-block is selected, for example the next macro-block 202 to the right of the first macro-block 201, and the process repeats for node pixels 241 of the remaining macro-blocks. Different coding modes and/or different patterns of node pixels can be used for different macro-blocks of the image 200. The method 250 can be implemented, at least in part, by a computing device, such as ASIC, microprocessor, FPGA, and the like.

The encoded macro-blocks 201 . . . 212 of the image 200 can be transmitted via a cable or a satellite, and/or stored in a digital storage medium such as an optical disk, a flash memory card, a hard drive, and the like. Depending on a particular compression mode, the cell and node pixel information of the encoded macro-blocks 201 . . . 212 can occupy much less memory than the values of the pixels of the image 200, allowing for more efficient storage and transmission. At a receiver site, or upon the read-out of the encoded macro-blocks 201 . . . 212, as the case may be, the macro-blocks 201 . . . 212 are decoded by a computing device. First, for at least the first macro-block 201, the values of the node pixels 241a . . . 241d are reconstructed; and then, the values of the cell pixels 242 of the first macro-block 201 using the reconstructed values of the node pixels 241a . . . 241d of the first macro-block 201. Thus, the node pixels 241a . . . 241d serve as “reference points” for improving accuracy and efficiency of encoding/decoding of the first macro-block 201.

Encoding of the node pixels 241a . . . 241d will now be briefly considered. Turning to FIG. 3, the step 253 of encoding node pixels includes a step 301 of intra-prediction. In one embodiment, the intra-prediction step 301 includes approximating the values of the node pixels 241a . . . 241d with an average value of the boundary pixels 230A and 230B. In another embodiment, the node pixels are encoded in an “interleaved” fashion. The node pixel 241a is first intra-predicted with an average value of the boundary pixels 230A and 230B. Then, node pixels 241b and 241c are encoded using the values of the reconstructed node pixel 241a and the boundary pixels 230A and 230B. The last node pixel 241d is further encoded using the reconstructed node pixels 241a, 241b, and 241c together with the boundary pixels 230A and 230B. The details of node pixel encoding are described further below. Referring again to FIG. 3, the intra-prediction step 301 is followed by a step 302 of spatial transform coding with quantization and entropy coding of the residuals of the node pixels 241a . . . 241d.

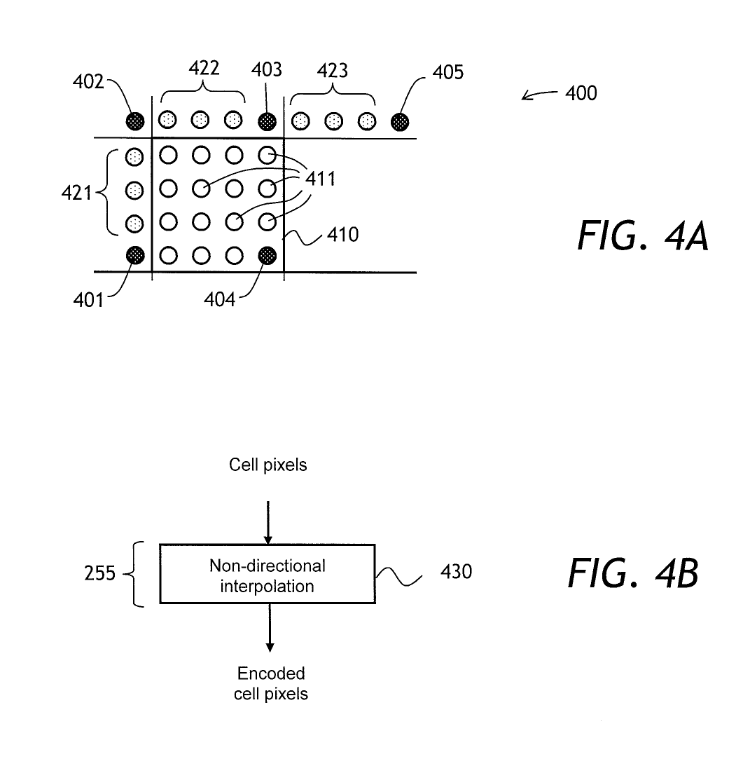

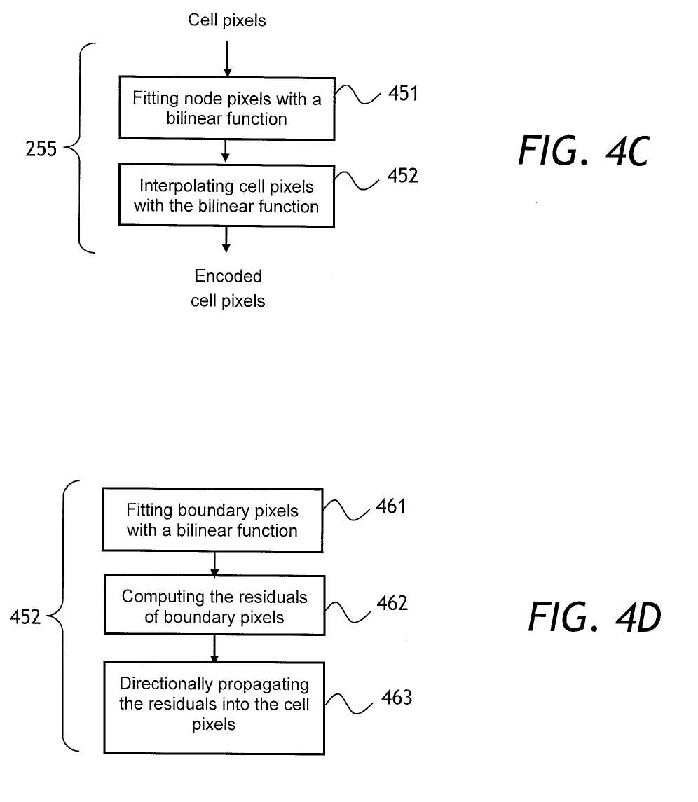

Once all node pixels of a macro-block are encoded, cell pixels can be encoded using reconstructed values of the node pixels as a reference. This is the step 255 of FIG. 2B. In one embodiment, the cell pixel encoding step 255 includes interpolation of cell pixels using neighboring decoded node pixels and boundary pixels of neighboring blocks. This is called non-directional interpolation. This method was found to work well for background areas of the image 200 having slowly varying luminosity and color. In another embodiment, directional interpolation of cell pixel values is used. Directional interpolation allows one to account for luminosity and color gradients in the image 200, allowing efficient encoding of more detailed areas of the image 200. A directional and non-directional interpolation technique for cell pixels will now be briefly discussed with reference to FIGS. 4A to 4D.

Referring to FIG. 4A, a macro-block 400 includes node pixels 401 . . . 405 and cell pixels 411. The cell pixels 411 form a sub-block 410 of the macro-block 400, defined by the first to the fourth node pixels 401 . . . 404, the sub-block 410 including the fourth node pixel 404, and the remaining node pixels 401 . . . 403 being disposed adjacent corners outside of the sub-block 410 as shown.

Referring to FIG. 4B, non-directional interpolation of the cell pixels 411 is performed in a step 430 using a linear interpolation function. Reconstructed node pixels 401, 402, 403, 404 and reconstructed cell pixels 422 and 421 are used for non-directional interpolation.

Referring to FIG. 4C, directional interpolation of the cell pixels 411 is preferably done in two steps. In a first step 451, values of the first to fourth node pixels 401 . . . 404 are fit with a bilinear function, to determine a set of fitting coefficients of the bilinear function. In a second step 452, a bilinear interpolation is performed for values of the cell pixels 411 of the sub-block 410 using the set of the bilinear function fitting coefficients determined in the first step 451.

Referring now to FIG. 4D, the second step 452 can include a step 461 of performing a bilinear interpolation of values of first and second boundary cell pixels 421, and 422, disposed between the first and the second 401 and 402; and the second and the third node pixels 402 and 403, respectively. The step 461 is followed by a step of computing residuals of the bilinear interpolation of the values of the first and second boundary cell pixels 421 and 422, which is followed by a step of directionally propagating the residuals of the values of the boundary cell pixels 421 and 422, computed in the previous step 462, into the cell pixels 411 of the sub-block 410. Herein, the term “directionally propagating” means adding the residuals to cell pixel values for pixels disposed along a certain direction from a boundary pixel having the particular value of the residual. A detailed description of one embodiment of this technique, employing eight pre-defined directions, will be provided further below.

In one embodiment, the fifth node pixel 405 is also used in the fitting step 451, in addition to the first to fourth node pixels 401 . . . 404. The fifth node pixel 405 is disposed in a same row of pixels as the second and the third node pixels 402 and 403, respectively, next to the third node pixel 403. In this embodiment, the node pixel fitting step 451 includes fitting the values of the first, second, third, and fourth node pixels 401, 402, 403, and 404, respectively, with the bilinear function. Also in this embodiment, the boundary pixel fitting step 461 includes performing a linear interpolation of values of third boundary cell pixels 423 disposed between the third and the fifth node pixels 403 and 405, respectively; and the residuals computing step 462 includes computing residuals of the linear interpolation of the values of third boundary pixels 423. Using of the fifth node pixel 405 allows one to increase the accuracy of directional prediction and to increase the number of pre-defined directions.

Node Pixel Encoding

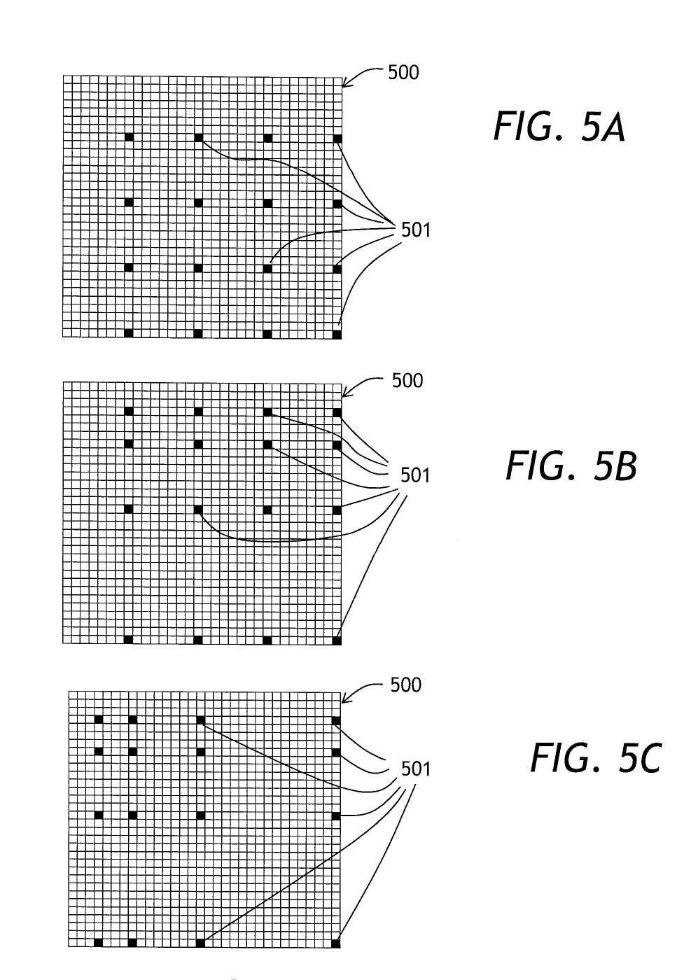

Exemplary methods of node pixel encoding will now be considered in detail. In a preferred implementation for high resolution video encoding, the size of macro-blocks is set to 32×32 pixels, the number of node pixels within a macro-block varying between 4×4, 8×8, and 16×16 pixels. Referring now to FIGS. 5A to 5C, example patterns of 4×4 node pixels 501 are shown for a 32×32 macro-block 500. In FIG. 5A, the node pixels 501 are evenly spaced. In FIG. 5B, the node pixels 501 are evenly spaced in horizontal direction and unevenly spaced in vertical direction. In FIG. 5C, the node pixels 501 are unevenly spaced in both horizontal and vertical directions. Different node pixel patterns can be used for different macro-blocks covering regions of different image detail. For example, the uneven patterns of the node pixels 501 of FIGS. 5B and 5C can be used for image regions having a higher level of detail close to the upper boundary and the upper-left corner, respectively, of the macro-blocks 500. Node pixels 501 of FIGS. 5A to 5C are non-adjacent, but node pixel patterns including adjacent node pixels can be used.

The 4×4 node pixels 501 can be encoded using the average value of previously encoded node and cell pixels that are on the column to the left of the macro-block 500 and on the row above the macro-block 500, not shown in FIGS. 5A to 5C. This known prediction method is referred to as “DC prediction” in the MPEG-4 AVC standard. Then, the residuals can be encoded using spatial transform coding with quantization and entropy encoding. In the implementation of the invention, the 4×4 discrete cosine transform (DCT) coding is preferably used for encoding the residuals.

Efficient node pixel encoding not only reduces the encoded bit rate, but also provides reconstructed node pixels with higher fidelity, thus serving as a more accurate reference for cell pixels interpolation. For 8×8 and 16×16 node pixels that are contained in a maro-block, one way to encode node pixels is to use intra-prediction modes defined in MPEG-4 AVC, and then encode the residuals. However, the intra-prediction defined in MPEG-4 AVC is quite complex and computationally intensive. It contains nine (9) modes for 4×4 blocks, and four (4) modes for 16×16 blocks. This large number of modes requires extra bits to indicate a mode selected for each block. To overcome this drawback, a following method is proposed for encoding 8×8 and 16×16 node pixels.

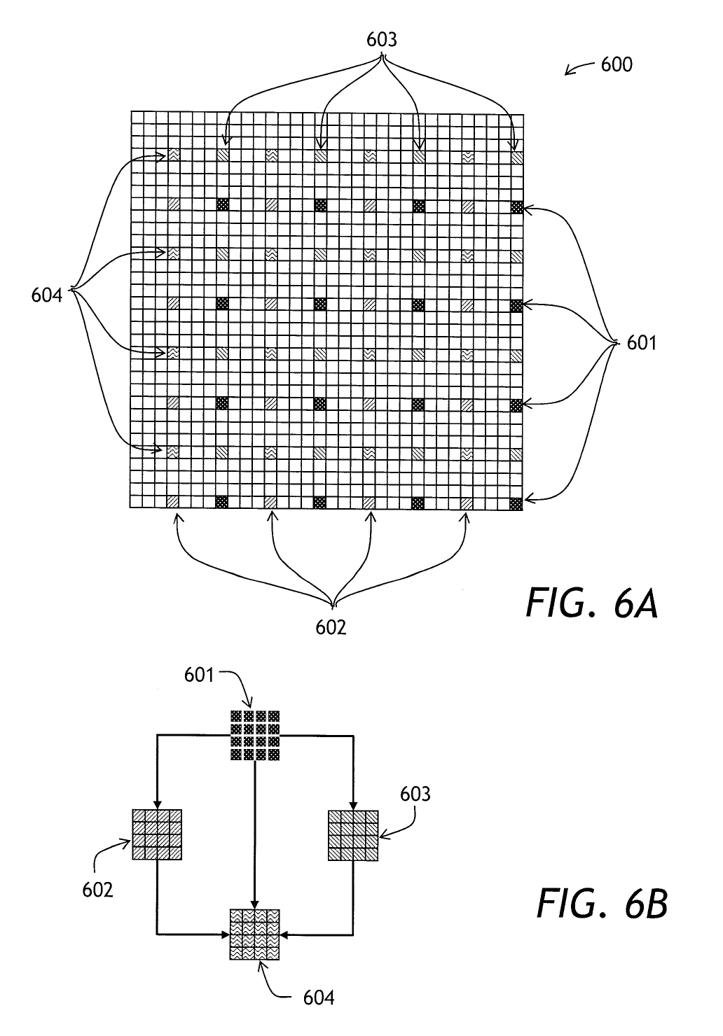

Referring to FIG. 6A, a macro-block 600 has a 8×8 array of node pixels including first to fourth interleaved 4×4 sub-arrays 601 . . . 604, respectively, of node pixels. Node pixels of any row of the first sub-array 601, shown as black squares with white dots, are interleaved with node pixels of a corresponding row of the second sub-array 602 shown in FIG. 6A as forward-slash squares. Node pixels of any column of the third sub-array 603, shown as backward-slash squares, are interleaved with node pixels of a corresponding column of the first sub-array 601. Node pixels of any row of the fourth sub-array 604, shown as wave-shaded squares, are interleaved with node pixels of a corresponding row of the third sub-array 603. Finally, node pixels of any column of the fourth sub-array 604 are interleaved with node pixels of a corresponding column of the second sub-array 602.

The 4×4 node pixels of the first sub-array 601 are termed base node pixels. The remaining node pixels of the second to fourth sub-arrays 602 . . . 604 are termed interleaved node pixels. The base node pixels 601 are encoded using a 4×4 DC intra prediction coding, followed by 4×4 DCT encoding of the residuals. After the 4×4 base node pixels 601 are encoded, they are decoded and reconstructed. Then, the decoded base node pixels are used to encode the interleaved node pixels of the second, third, and fourth sub-arrays 602, 603, and 604. Referring now to FIG. 6B, the values of the node pixels of the second to fourth sub-arrays 602 . . . 604 are encoded using the reconstructed values of the node pixels of the first sub-array 601. The values of the node pixels of the fourth sub-array 604 can also be encoded using the reconstructed values of the node pixels of the second and third sub-arrays 602 and 603, respectively.

Preferably, the encoding of the interleaved node pixels is done by interpolation, and further, preferably, the interpolation is a one-dimensional interpolation. For example, rows of the node pixels of the second sub-array 602 are interpolated using rows of the base node pixels 601; columns of the node pixels of the third sub-array 603 are interpolated using columns of the base node pixels 601; rows of the node pixels of the fourth sub-array 604 are interpolated using rows of the node pixels of the third sub-array 603; and columns of the node pixels of the fourth sub-array 604 are interpolated using columns of the node pixels of the second sub-array 602. Furthermore, node pixels of the fourth sub-array 604 can be interpolated diagonally using diagonally disposed base node pixels of the first sub-array 601. Node pixels of the fourth sub-array 604 can also be interpolated by avearging the values of node pixels around them, namely: node pixels of sub-array 610, 602, and 603.

The interpolation can be carried out using a traditional interpolation technique such as bi-linear filtering, cubic filtering, or the 6-tap filtering defined in MPEG-4 AVC. The interpolation can also be carried out using adaptive interpolation, which uses directional information to give a more accurate interpolation result. The interpolation residuals of the base and interpolated node pixels, that is, the differences between the interpolated and original values of the base and interpolated node pixels, are further calculated and encoded using spatial transform based coding methods, such as 4×4 DCT.

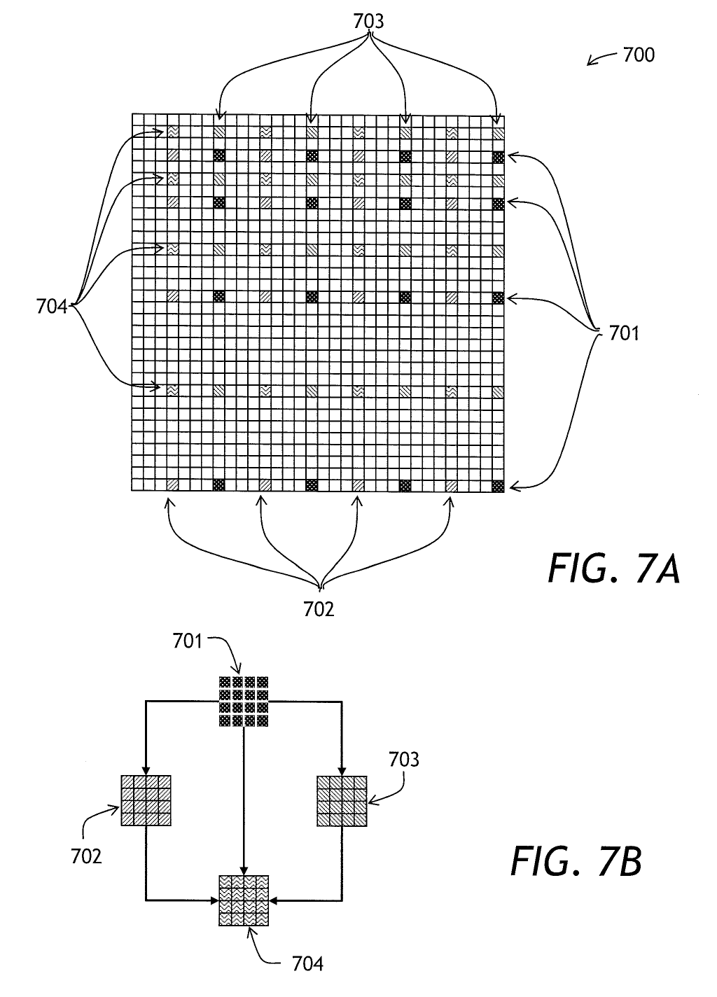

Referring now to FIGS. 7A and 7B, a macro-block 700 has a 8×8 array of node pixels including first to fourth interleaved 4×4 sub-arrays 701 . . . 704, respectively, of node pixels. The difference between FIGS. 7A and 6A is that the node pixels of the 4×4 sub-arrays 701 . . . 704 are not distributed evenly. The node pixels of the sub-arrays 701 . . . 704 are encoded in the same manner as the node pixels of the sub-arrays 601 . . . 604 of FIGS. 6A and 6B.

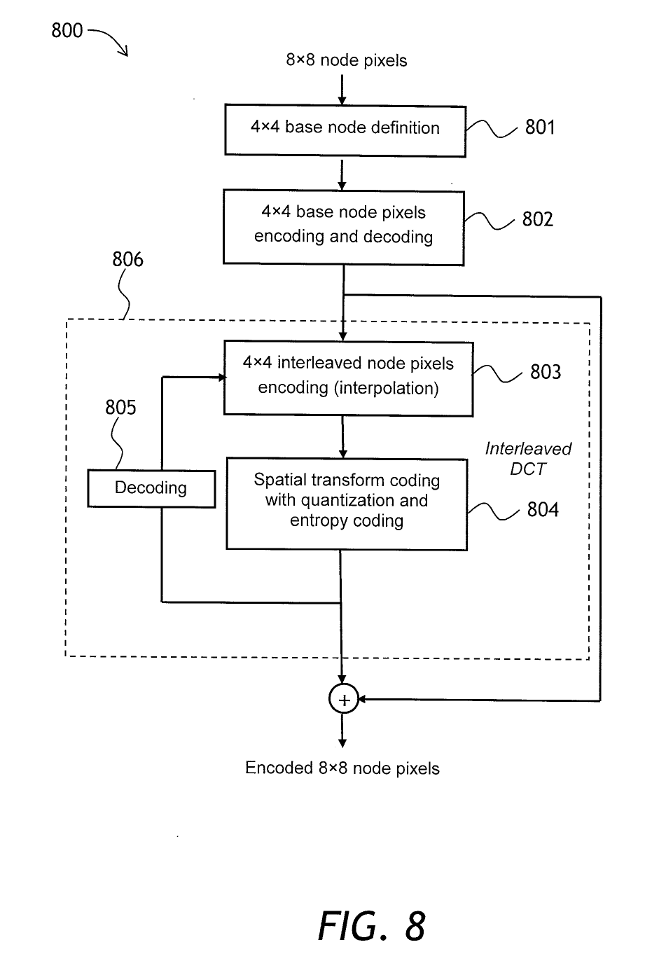

Referring to FIG. 8 in conjunction with FIGS. 7A, 7B and 6A, 6B, a method 800 of encoding 8×8 node pixels is presented. In a step 801, the 4×4 base node pixels of the first sub-array 601 or 701 are defined. In a step 802, the 4×4 base node pixels are encoded as base node pixel information and then decoded. In a step 803, the 4×4 interleaved node pixels of the second to fourth sub-arrays 602 . . . 604 or 702 . . . 704 are defined and encoded, preferably interpolated, using values of the base node pixels that have been reconstructed from the base node pixel information. In an optional step 804, the residuals of the interpolation of the previous step 802 are spatial-transform coded, preferably DCT-coded, with quantization and entropy coding. A decoding step 805 may be required to encode the 4×4 interleaved node pixels of the fourth sub-array 604 or 704 using the decoded node pixels of the second and third sub-arrays 602 . . . 603 or 702 . . . 703, as described above. A sub-process 806 of interleaving and encoding the 4×4 interleaved node pixels using a DCT transform is termed herein “Interleaved DCT”.

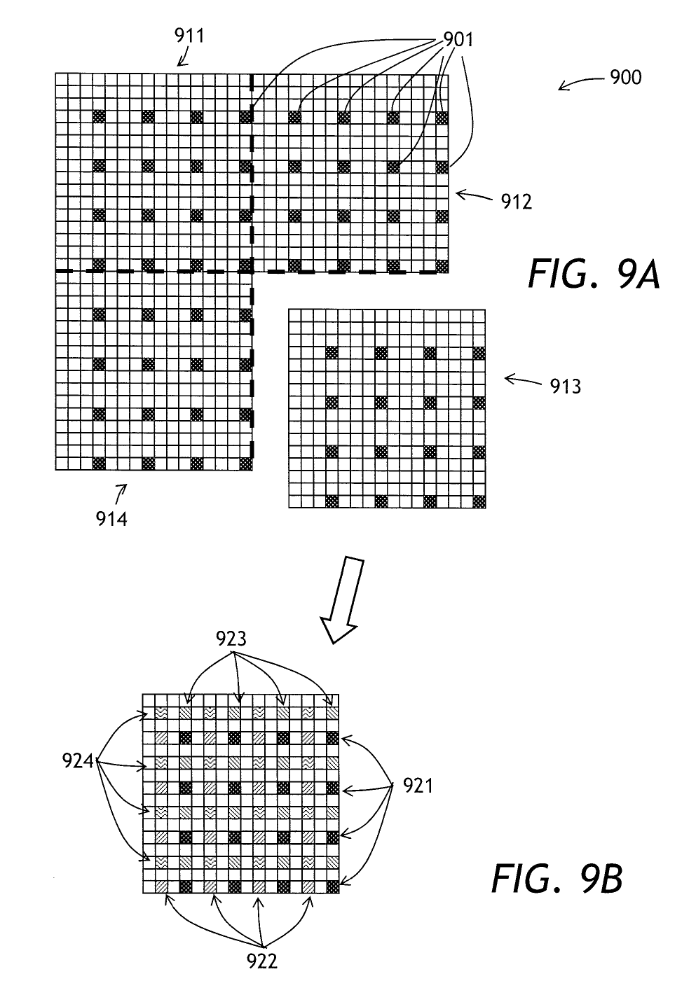

Referring to FIGS. 9A and 9B, the encoding process for 16×16 node pixels of a 32×32 macro-block 900 is illustrated. The first step is to define and encode 8×8 base node pixels 901 shown in FIG. 9A as black squares with white dots. The 8×8 base node pixels are encoded using the encoding process 800 described above. Then, the 32×32 macro-block 900 is divided into four sub-blocks 911 . . . 914. The third sub-block 913 is shown in a cut-out form in FIG. 9A. Each 16×16 sub-block 911 . . . 914 contains 4×4 base node pixels 921 that have been encoded. Referring specifically to FIG. 9B, the other node pixels 922, 923, and 924, indicated by forward-hashed, backward-hashed, and wavy-hashed squares, respectively, are interpolated using the above-described Interleaved DCT process. The interpolation dependence is the same as in the above method 800 of FIG. 8.

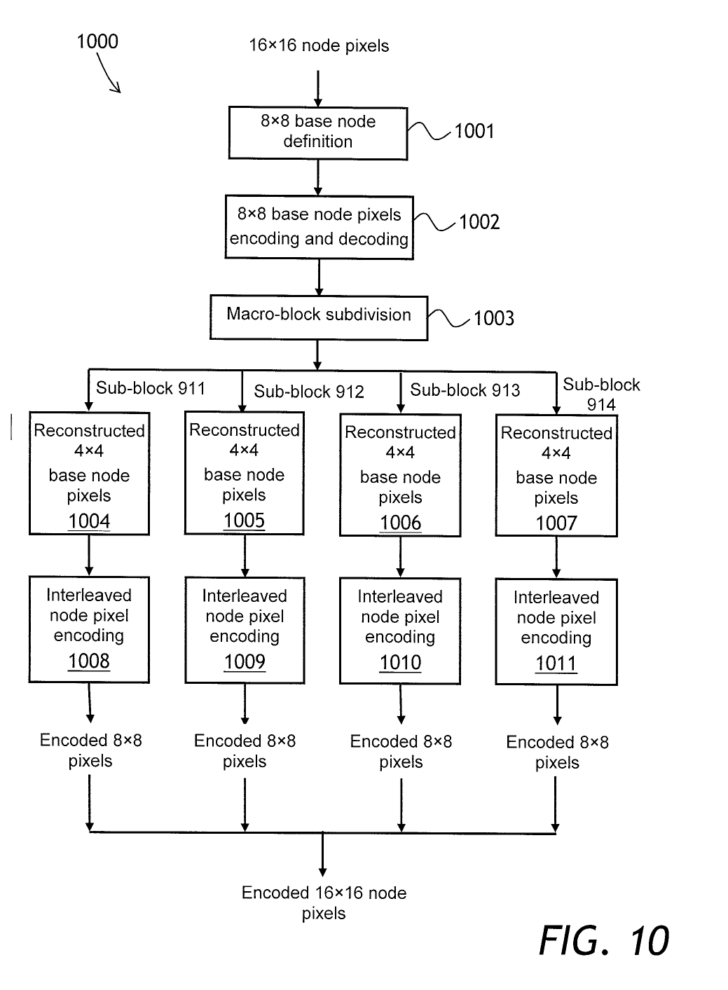

Referring now to FIG. 10 in conjunction with FIGS. 9A, 9B, a method 1000 of encoding 16×16 node pixels is presented. In a step 1001, the 8×8 base node pixels 901 are defined. In a step 1002, the 8×8 base node pixels are encoded using the Interleaved DCT method 800 of FIG. 8. In a step 1003, the macro-block 900 is sub-divided into the four sub-blocks 911 . . . 914. Then, for each of the sub-blocks 911 . . . 914, the following steps are performed. In steps 1004 . . . 1007, respectively, 4×4 base node pixels 921, which are sub-array node pixels of the decoded/reconstructed 8×8 base node pixels, are defined and used for encoding remaining node pixels of the sub-blocks 911 . . . 914. In steps 1008 . . . 1011, respectively, the 4×4 interleaved node pixels 922 . . . 924 are defined and encoded. The four respective sets of the encoded 8×8 pixels 921 . . . 924 form encoded 16×16 node pixels of the macro-block 900.

The cell pixels of the macro-block 900 having 16×16 node pixels can be encoded in a similar fashion, by applying Interleaved DCT process to the remaining cell pixels, followed by an optional spatial-transform coding of the residuals. This is equivalent to allocating and Interleaved-DCT encoding all 32×32 pixels as node pixels.

Generally, the node pixel interpolation method described above will work with a 2M×2N rectangular array of pixels, wherein M and N are integers≧2. The number of sub-arrays can vary from two to four and more sub-arrays. The spatial transform coding can include, for example, DCT, wavelet transform (WT), a fast Fourier transform, and the like.

The above described methods of 4×4, 8×8, and 16×16 node pixel encoding in a 32×32 macro-block have different encoding efficiency and quality. Generally, the more node pixels are in a macro-block, the closer the cell pixels are to their reference node pixels, which generally leads to more accurate interpolation result. Any intra-prediction or interpolation method can be used to encode the base node pixels 601 and 701, although some methods will work better than others. Quantization of the spatial-transform coded residuals can be employed to further compress the image.

Cell Pixel Encoding

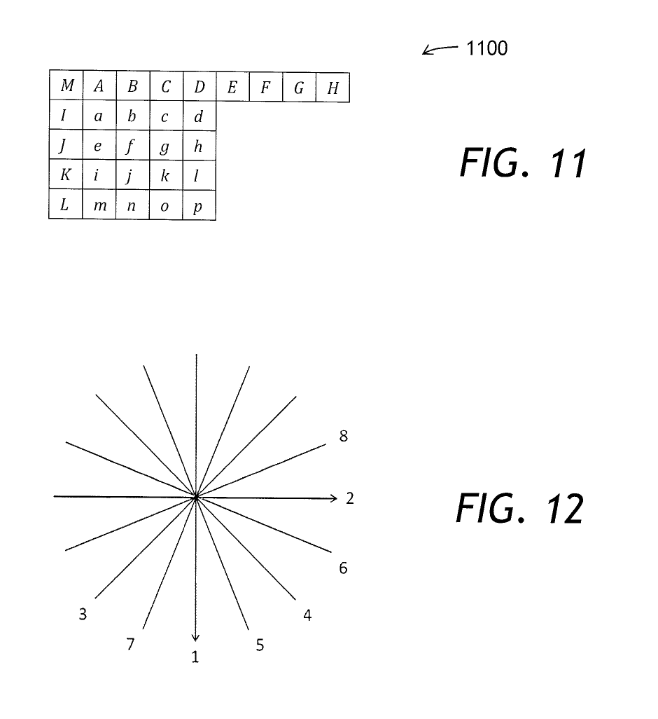

Turning now to FIG. 11, a sub-block 1100 corresponds to the sub-block 400 of FIG. 4A. The node pixels 401 . . . 403 and 405 and the first to third boundary cell pixels 421 . . . 423 of the sub-block 400 correspond to pixels A . . . L of FIG. 11. The cell pixels 411 correspond to pixels a . . . o of FIG. 11, and the fourth node pixel 404 corresponds to pixel p shown in FIG. 11.

For non-directional interpolation shown in FIG. 4B, cell pixels d, h and l are linearly interpolated using the reconstructed node pixels D and p. Then cell pixels m, n and o are linearly interpolated using the reconstructed node pixels L and p. The remaining cell pixels are the weighting results of horizontal interpolation and vertical interpolation. For example, for cell pixel f, its vertical interpolation value is calculated using reconstructed cell pixel value B and interpolated cell pixel value n, its horizontal interpolation value is calculated using reconstructed cell pixel value J and interpolated cell pixel value h. Then the value of cell pixel f is calculated by a weighting average of the vertical interpolation value and horizontal interpolation value.

For the directional interpolation, the offsets of the 4×4 sub-block are modeled by a bilinear function

offset(x,y)=βx+δy+ζxy+η

where (x,y) denote the spatial location of the pixels A . . . L and a . . . p within the sub-block 400. The Greek letters β, δ, ζ, η denote parameters of the offset function. The parameters of the offset function are determined using the values of pixels M, L, D, and p, which are known. Then, the offset value of every pixel shown in FIG. 11 is calculated with this determined bilinear function. As the pixels from A to M have been previously encoded and their decoded values are known, their offset residuals are calculated as follows:

Sᵣₑₛ=S−offset(S)

where S stands for the pixel value of the pixels A . . . M.

Once the offset values within the sub-block and the offset residuals of the neighboring pixels are calculated, the offset residuals are directionally propagated into the sub-block and added to the offsets of every pixels within the sub-block as follows.

Referring to FIG. 12, eight pre-defined directions for directional intra-prediction of the cell pixels a . . . o are denoted as 1 to 8. The directions 1 to 8 correspond to eight modes for the directional prediction defined in the H.264 encoding standard.

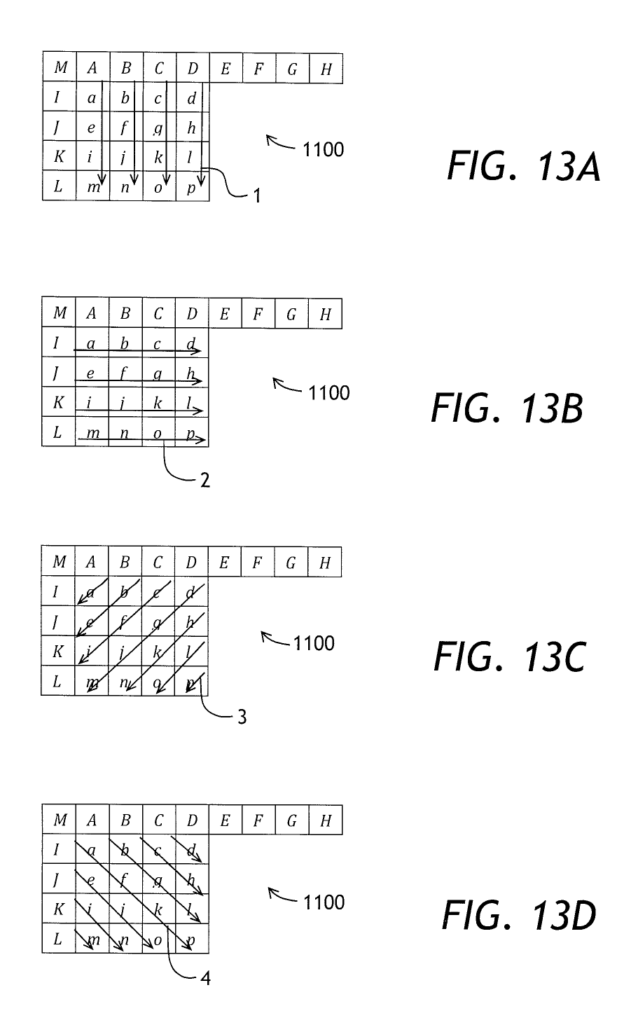

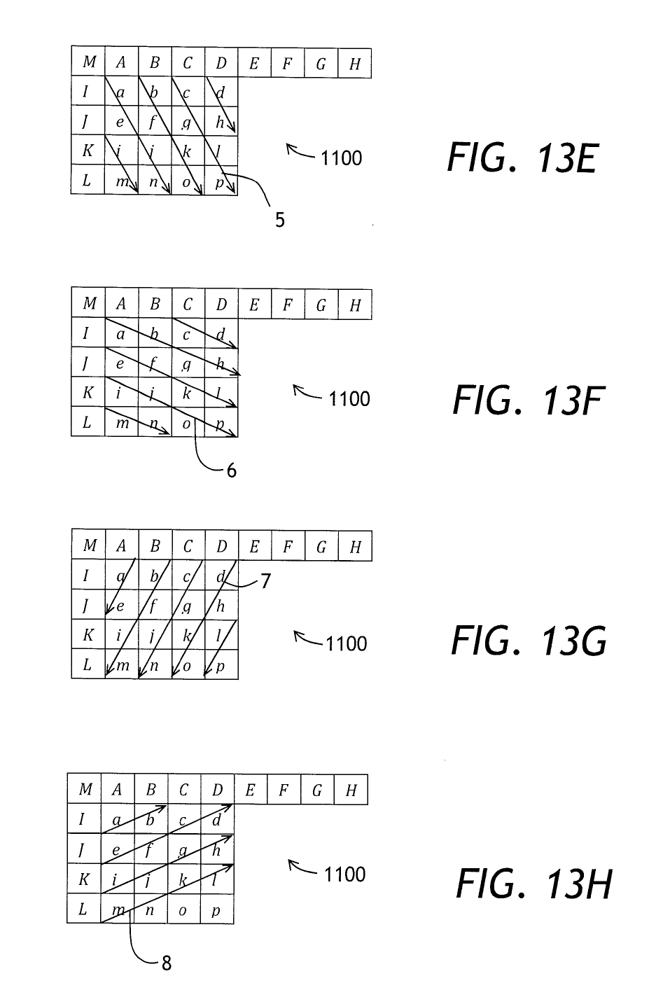

The propagation of the residuals in the eight directions 1 to 8 will now be considered. Referring now to FIGS. 13A to 13H, the sub-block 400 is redrawn with the directions 1 . . . 8 explicitly shown. Referring specifically to FIG. 13A, the offset residuals for the first row, including pixels A, B, C and D, is calculated as

Aᵣₑₛ=A−offset(A)

Bᵣₑₛ=B−offset(B)

Cᵣₑₛ=C−offset(C)

Dᵣₑₛ=D−offset(D)

Then, the directional prediction values of the cell pixels a . . . o are calculated as follows:

a=offset(a)+Aᵣₑₛ

e=offset(e)+Aᵣₑₛ

i=offset(i)+Aᵣₑₛ

m=offset(m)+Aᵣₑₛ

b=offset(b)+Bᵣₑₛ

f=offset(f)+Bᵣₑₛ

j=offset(j)+Bᵣₑₛ

n=offset(n)+Bᵣₑₛ.

c=offset(c)+Cᵣₑₛ

g=offset(g)+Cᵣₑₛ

k=offset(k)+Cᵣₑₛ

o=offset(o)+Cᵣₑₛ

d=offset(d)+Dᵣₑₛ

h=offset(h)+Dᵣₑₛ

l=offset(l)+Dᵣₑₛ

Referring specifically to FIG. 13B, the offset residuals for the first column, including pixels I, J, K and L, are calculated as

Iᵣₑₛ=I−offset(I)

Jᵣₑₛ=J−offset(J)

Kᵣₑₛ=K−offset(K)

Lᵣₑₛ=L−offset(L)

The cell pixels of each row within the sub-block are predicted by the sum of the offset of cell pixels and the corresponding offset residual of this row, similar to the vertical direction prediction shown in FIG. 13A.

Referring specifically to FIG. 13C, the cell pixels a . . . o are grouped as follows:

G1: a

G2: b, e

G3: c, f, i

G4: d, g, j, m

G5: h, k, n

G6: l, o

The offset residuals for this diagonal direction are first filtered as follows:

Offset_Residual_{—}G1=(Aᵣₑₛ+2*Bᵣₑₛ+Cᵣₑₛ)/4

Offset_Residual_{—}G2=(Bᵣₑₛ+2*Cᵣₑₛ+Dᵣₑₛ)/4

Offset_Residual_{—}G3=(Cᵣₑₛ+2*Dᵣₑₛ+Eᵣₑₛ)/4

Offset_Residual_{—}G4=(Dᵣₑₛ+2*Eᵣₑₛ+Fᵣₑₛ)/4

Offset_Residual_{—}G5=(Eᵣₑₛ+2*Fᵣₑₛ+Gᵣₑₛ)/4

Offset_Residual_{—}G6=(Fᵣₑₛ+2*Gᵣₑₛ+Hᵣₑₛ)/4

Then, the pixel values in each group are compensated by adding the offset residual to its corresponding offset.

In another embodiment, cell pixels in G1, G2, and G3 are interpolated using pixels A, B, C, D, E, I, J, K, and L.

Referring specifically to FIG. 13D, the cell pixels a . . . o are grouped as follows:

G1: d

G2: c, h

G3: b, g, l

G4: a, f k

G5: e, j, o

G6: i, n

G7: m

The offset residuals for this diagonal direction are first filtered as follows:

Offset_Residual_{—}G1=(Bᵣₑₛ+2*Cᵣₑₛ+Dᵣₑₛ)/4

Offset_Residual_{—}G2=(Aᵣₑₛ+2*Bᵣₑₛ+Cᵣₑₛ)/4

Offset_Residual_{—}G3=(Mᵣₑₛ+2*Aᵣₑₛ+Bᵣₑₛ)/4

Offset_Residual_{—}G4=(Iᵣₑₛ+2*Mᵣₑₛ+Aᵣₑₛ)/4

Offset_Residual_{—}G5=(Mᵣₑₛ+2*Iᵣₑₛ+Jᵣₑₛ)/4

Offset_Residual_{—}G6=(Iᵣₑₛ+2*Jᵣₑₛ+Kᵣₑₛ)/4

Offset_Residual_{—}G7=(Jᵣₑₛ+2*Kᵣₑₛ+Lᵣₑₛ)/4

Once the offset residual for each group is filtered, the cell pixels in each group are predicted by adding its offset residual to its offset, namely:

d=offset(d)+Offset_Residual_{—}G1

c=offset(c)+Offset_Residual_{—}G2

h=offset(h)+Offset_Residual_{—}G2

b=offset(b)+Offset_Residual_{—}G3

g=offset(g)+Offset_Residual_{—}G3

l=offset(l)+Offset_Residual_{—}G3

a=offset(a)+Offset_Residual_{—}G4

f=offset(f)+Offset_Residual_{—}G4

k=offset(k)+Offset_Residual_{—}G4

e=offset(e)+Offset_Residual_{—}G5

j=offset(j)+Offset_Residual_{—}G5

o=offset(o)+Offset_Residual_{—}G5

i=offset(i)+Offset_Residual_{—}G6

n=offset(n)+Offset_Residual_{—}G6

m=offset(m)+Offset_Residual_{—}G7

Referring specifically to FIG. 13E, the cell pixels a . . . o are grouped as follows:

G1: d

G2: h

G3: c, l

G4: g,

G5: b, k

G6: f, o

G7: a, j

G8: e, n

G9: i

G10: m

The vertical right directional offset residuals are calculated as follows:

Offset_Residual_{—}G1=(Cᵣₑₛ+Dᵣₑₛ)/2

Offset_Residual_{—}G2=(Bᵣₑₛ+2*Cᵣₑₛ+Dᵣₑₛ)/4

Offset_Residual_{—}G3=(Bᵣₑₛ+Cᵣₑₛ)/2

Offset_Residual_{—}G4=(Aᵣₑₛ+2*Bᵣₑₛ+Cᵣₑₛ)/4

Offset_Residual_{—}G5=(Aᵣₑₛ+Bᵣₑₛ)/2

Offset_Residual_{—}G6=(Mᵣₑₛ+2*Aᵣₑₛ+Bᵣₑₛ)/4

Offset_Residual_{—}G7=(Mᵣₑₛ+Aᵣₑₛ)/2

Offset_Residual_{—}G8=(Aᵣₑₛ+2*Mᵣₑₛ+Iᵣₑₛ)/4

Offset_Residual_{—}G9=(Mᵣₑₛ+2*Iᵣₑₛ+Jᵣₑₛ)/4

Offset_Residual_{—}G10=(Iᵣₑₛ+2*Jᵣₑₛ+Kᵣₑₛ)/4

Then, the pixel values in each group are compensated by adding the offset residual to its corresponding offset.

Referring specifically to FIG. 13F, the cell pixels a . . . o are grouped as follows:

G1: d

G2: c

G3: b, h

G4: a, g

G5: f, l

G6: e, k

G7: j

G8: i, o

G9: n

G10: m

The offset residuals for this direction are calculated as follows:

Offset_Residual_{—}G1=(Aᵣₑₛ+2*Bᵣₑₛ+Cᵣₑₛ)/4

Offset_Residual_{—}G2=(Mᵣₑₛ+2*Aᵣₑₛ+Bᵣₑₛ)/4

Offset_Residual_{—}G3=(Iᵣₑₛ+2*Mᵣₑₛ+Aᵣₑₛ)/4

Offset_Residual_{—}G4=(Mᵣₑₛ+Iᵣₑₛ)/2

Offset_Residual_{—}G5=(Mᵣₑₛ+2*Iᵣₑₛ+Jᵣₑₛ)/4

Offset_Residual_{—}G6=(Iᵣₑₛ+Jᵣₑₛ)/2

Offset_Residual_{—}G7=(Iᵣₑₛ+2*Jᵣₑₛ+Kᵣₑₛ)/4

Offset_Residual_{—}G8=(Jᵣₑₛ+Kᵣₑₛ)/2

Offset_Residual_{—}G9=(Jᵣₑₛ+2*Kᵣₑₛ+Lᵣₑₛ)/4

Offset_Residual_{—}G10=(Kᵣₑₛ+Lᵣₑₛ)/2

Then, the pixel values in each group are compensated by adding the offset residual to its corresponding offset.

Referring specifically to FIG. 13G, the cell pixels a . . . o are grouped as follows:

G1: a

G2: e

G3: b, i

G4: f, m

G5: c, j

G6: g, n

G7: d, k

G8: h, o

G9: l

The vertical right directional offset residuals are calculated as follows:

Offset_Residual_{—}g1=(Aᵣₑₛ+Bᵣₑₛ)/2

Offset_Residual_{—}g2=(Aᵣₑₛ+2*Bᵣₑₛ+Cᵣₑₛ)/4

Offset_Residual_{—}g3=(Bᵣₑₛ+Cᵣₑₛ)/2

Offset_Residual_{—}g4=(Bᵣₑₛ+2*Cᵣₑₛ+Dᵣₑₛ)/4

Offset_Residual_{—}g5=(Cᵣₑₛ+Dᵣₑₛ)/2

Offset_Residual_{—}g6=(Cᵣₑₛ+2*Dᵣₑₛ+Eᵣₑₛ)/4

Offset_Residual_{—}g7=(Dᵣₑₛ+Eᵣₑₛ)/2

Offset_Residual_{—}g8=(Dᵣₑₛ+2*Eᵣₑₛ+Fᵣₑₛ)/4

Offset_Residual_{—}g9=(Eᵣₑₛ+Fᵣₑₛ)/2

Then, the pixel values in each group are compensated by adding the offset residual to its corresponding offset.

In another embodiment, cell pixels in G1, G2, and G3 are interpolated using pixels A, B, C, J, K, and L.

Referring now specifically to FIG. 13H, the cell pixels a . . . o are grouped as follows:

G1: a

G2: b

G3: e, c

G4: f, d

G5: i, g

G6: j, h

G7: m, k

G8: n, l

G9: o

The horizontal left directional offset residuals are calculated as follows:

Offset_Residual_{—}g1=(Iᵣₑₛ+Jᵣₑₛ)/2

Offset_Residual_{—}g2=(Iᵣₑₛ+2*Jᵣₑₛ+Kᵣₑₛ)/4

Offset_Residual_{—}g3=(Jᵣₑₛ+Kᵣₑₛ)/2

Offset_Residual_{—}g4=(Jᵣₑₛ+2*Kᵣₑₛ+Lᵣₑₛ)/4

Offset_Residual_{—}g5=(Kᵣₑₛ+Lᵣₑₛ)/2

Offset_Residual_{—}g6=(Kᵣₑₛ+2*Lᵣₑₛ+Lᵣₑₛ)/4

Offset_Residual_{—}g7=0

Offset_Residual_{—}g8=0

Offset_Residual_{—}g9=0

Then, the pixel values in each group are compensated by adding the offset residual to its corresponding offset.

In another embodiment, cell pixels in G1, G2, G3, G4, G5, and G6 are interpolated using pixels I, J, K, L, B, C, D, E, F, G, and H.

More generally, one can use weighted offset residuals to replace the prediction compensated offset residual, as per following equation:

s=offset(s)+γ*offset_residual_predicted

wherein s stands for any cell pixels from a to o as shown in FIG. 11, and the offset-residual_predicted is a single value that is calculated along one pre-defined direction. The weighting factor γ is gradually reduced as the cell pixel is away from the known neighboring pixels. An optimal value of the weighting factor γ can be determined experimentally.

The directional cell pixel interpolation disclosed above can be extended to 8×8 and larger blocks. It can also be extended to any practical number of interpolation directions.

Once the adaptive interpolation with offset prediction is calculated for cell pixels a . . . o of the sub-block 1100, the residual between the original pixels and the interpolated pixels will be calculated and encoded using DCT-based entropy encoding.

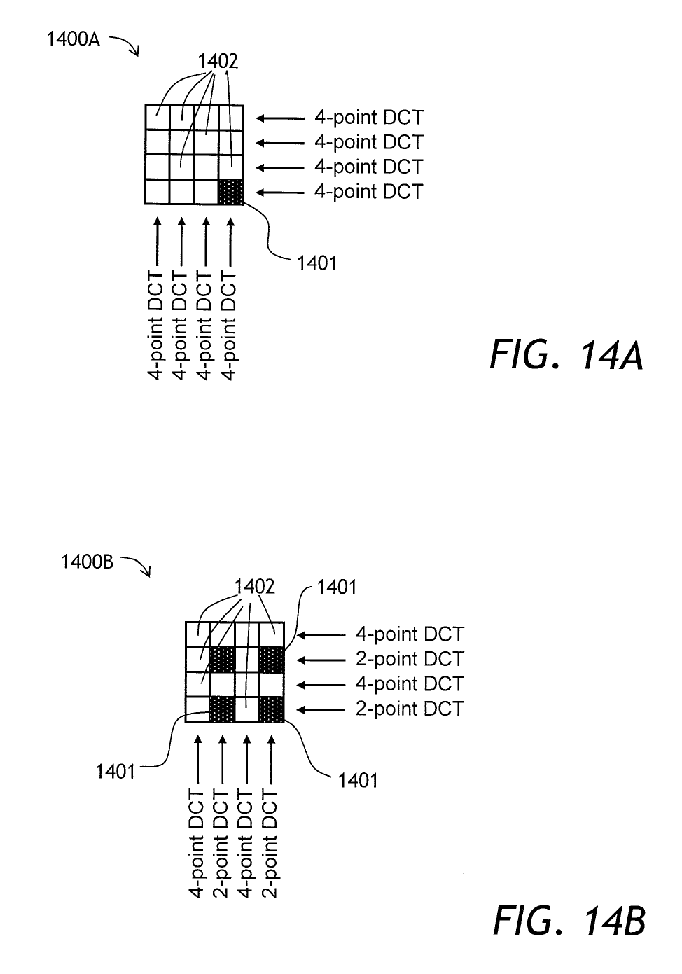

After cell pixel interpolation and cell residual calculation, a macro-block is divided into sub-blocks for DCT transform. Referring to FIGS. 14A and 14B, 4×4 sub-blocks 1400A and 1400B are shown. Each of the sub-blocks 1400A and 1400B contains cell pixels 1402 as well as some node pixels 1401. The interpolation residuals of the cell pixels 1402 need to be encoded, whereas the residuals of node pixels 1401 do not, because they have been previously encoded. The conventional 2-D DCT applies to all pixels in the sub-blocks 1400A and 1400B, including the node pixels 1401. This is not optimal, because node pixels are encoded twice.

For the sub-block 1400A of FIG. 14A, including fifteen cell pixels 1402 and only one node pixel 1401, the bit waste is not significant because the number of the node pixels 1401 is 15 times smaller than the number of the cell pixels 1402. In this case, the residuals at the location of the node pixels can be set to zero, so that the conventional DCT can be applied to the entire sub-block 1400A.

For the sub-block 1400B of FIG. 14B, including twelve cell pixels 1402 and four node pixels 1401, the bit waste is no longer insignificant. In this case, each odd row and column has four cell pixels 1402 and each even row and column has two cell pixels 1402. In this case, the DCT of two different lengths can be employed. A one-dimensional (1-D) DCT of length four is applied to each odd numbered row, and a 1-D DCT of the length two is applied to each even numbered row for the horizontal DCT. After that, the DCT coefficients are assigned to the locations of the corresponding cell pixels 1402. Then, the DCT of two different lengths is applied. A 1-D DCT of length four is applied to each odd numbered column, and a 1-D DCT of length two is applied to each even numbered column for the vertical DCT transform. The final DCT coefficients are again assigned to the locations of the corresponding cell pixels. This results in 12 DCT coefficients, same as the number of cell pixels in the sub-block 1400B. For zigzag scanning of the DCT coefficients, the locations of the node pixels are skipped to reduce the number of the bits for encoding the DCT coefficients. The encoding process described above can be generalized to 2N×2N sub-blocks, wherein N is an integer≧2.

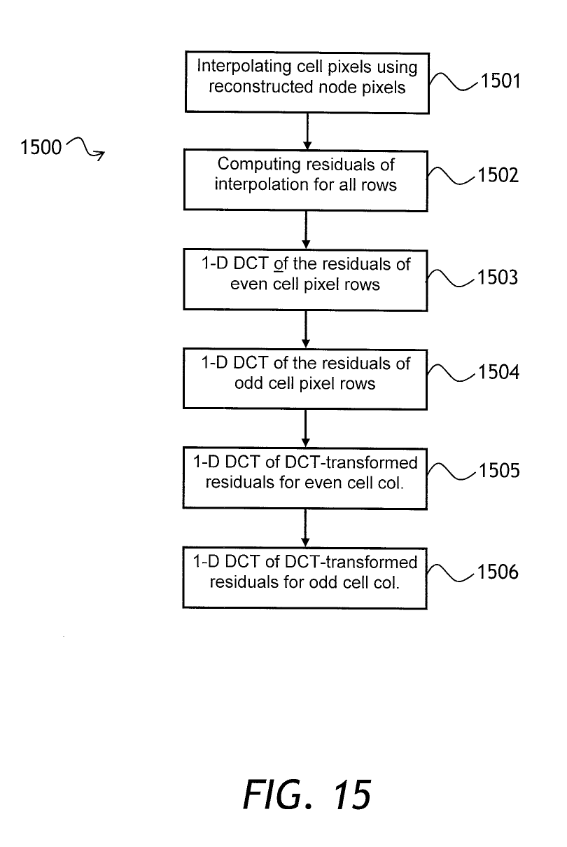

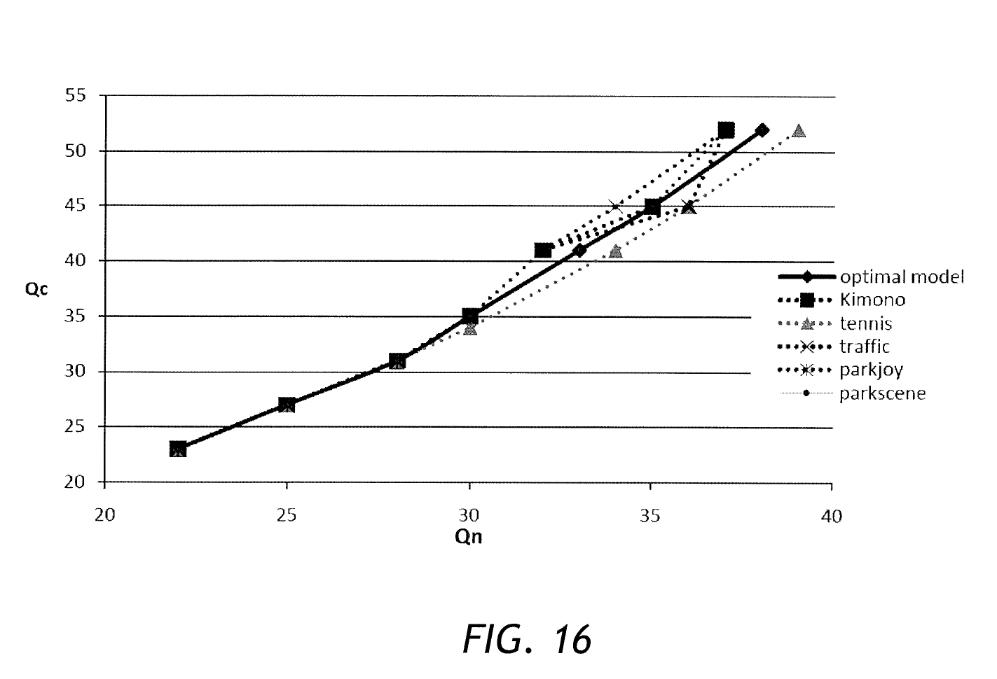

Referring now to FIG. 15 with further reference to FIG. 14B, a process 1500 of 1-D DCT based cell pixel encoding begins with a step 1501 of interpolating values of the cell pixels 1402 of the sub-block 1400B using the reconstructed values of the node pixels 1401. In a step 1502, residuals of the interpolation of the previous step 1501 are computed for even and odd rows of the cell pixels 1402 of the sub-block 1400B. In a step 1503, one-dimensional DCT-transform of residuals is performed for the even rows of the cell pixels 1402 of the sub-block 1400B. In a step 1504, one-dimensional DCT transform of residuals is performed for the odd rows of the cell pixels 1402 of the sub-block 1400B. Upon completion of the steps 1503 and 1504 of DCT transform of residuals, a step 1505 of one-dimensional DCT transform of DCT-transformed residuals of the steps 1503 and 1504 is performed for the even columns of the cell pixels 1402 of the sub-block 1400B. Then, a step 1506 of one-dimensional DCT transform of DCT-transformed residuals of the steps 1503 and 1504 for the odd columns of the cell pixels 1402 of the sub-block 1400B is performed. The length of the one-dimensional DCT transforms in the steps 1503 and 1504; and 1504 and 1505 is different due to different number of pixels in the odd and even rows/columns of the cell pixels 1402. The process can be repeated for each sub-block 1400B of a macro-block, not shown in FIG. 14B.

Quantization parameters for the node and cell pixels can be optimized for a more efficient encoding. The quantization parameter Q_{C} for the cell pixels should be different from the quantization parameter Q_{N} for the node pixels in order to achieve a higher compression efficiency. This is because the coding errors of the node pixels come from the quantization of the node pixels, whereas the coding errors of cell pixels are the result of the quantization of both the node and cell pixels. At the decoder side, the cell pixels are first interpolated using the decoded node pixels. The residuals of the cell pixels are then decoded and added to the interpolation result to reconstruct the cell pixels. Given a quantization parameter Q_{C} for the cell pixels, if the node pixels are quantized with a smaller quantization step, the coding errors of the node pixels are smaller. In this case, the cell pixel interpolation is generally more accurate and the interpolation residuals need fewer bits to encode. Therefore, the quantization parameter Q_{N} for the node pixels should be smaller than the quantization parameter Q_{C} for the cell pixels.

A relationship between the two quantization parameters, Q_{N} and Q_{C}, is described by the following model of the optimal Q_{C} for the cell pixels based on the quantization parameter Q_{N} for the node pixels:

Q_{C}=αQ_{N}²+βQ_{N}+γ

where α, β and γ are three positive parameters that are determined from the empirical data. These parameters can be pre-defined for an encoding-decoding system, which allows one to send only one of the parameters Q_{N} or Q_{C} for each macro-block, each frame, or each video sequence, to a decoding part of the system.

Referring to FIG. 16, an optimal functional relationship between Q_{N} and Q_{C} is shown with thick black line. The optimal functional relationship corresponds to α, β and γ of 0.0215, 0.48 and 1.5, respectively. The experimentally determined best-case Q_{N} and Q_{C} is shown for Kimono, Tennis, Traffic, Park Joy, and Park Scene standard video sequences in squares, triangles, crosses, double-crosses, and dots, respectively. It is seen from FIG. 16 that the optimal Q_{C} is always larger than Q_{N}, and the difference between the two quantization parameters becomes larger with the increase of Q_{N}.

Rate-Distortion Optimization

In digital video transmission, a tradeoff exists between the bitrate required for transmission, and distortion of video frames due to compression afforded by a particular coding mode. An image or a video frame frequently has areas of different level of detail and texture. Consequently, when the image is divided into macro-blocks, optimal coding modes of different macro-blocks can differ from each other. Accordingly, in a preferred embodiment of the invention, an optimal coding mode is selected out of a plurality of pre-defined coding modes for each macro-block of an image or a video frame.

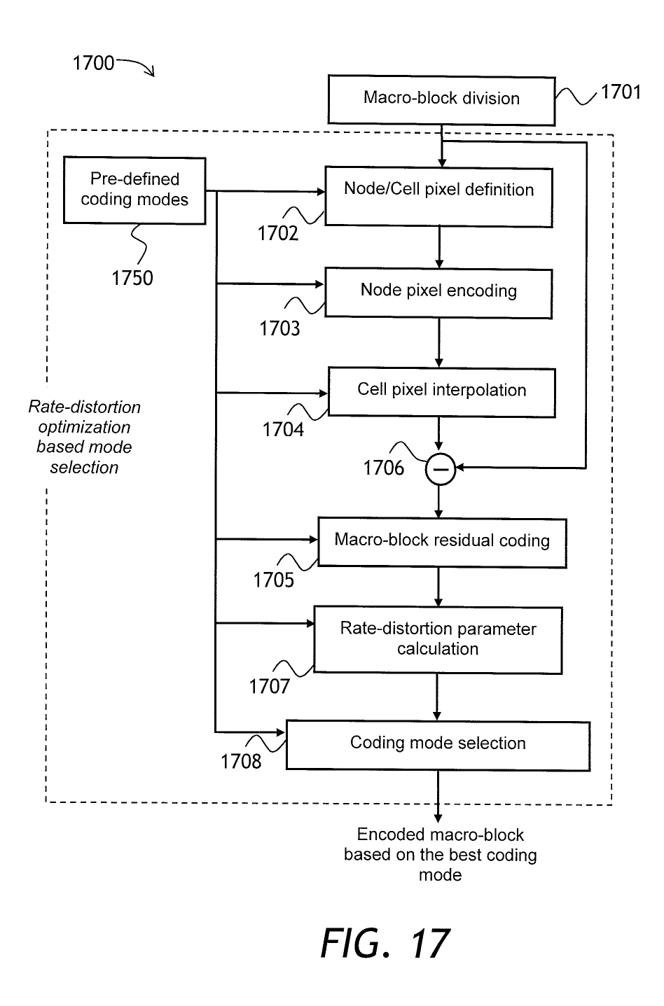

Referring to FIG. 17 with a further reference to FIG. 2A, an image encoding method 1700 takes advantage of a coding mode optimization. A plurality of coding modes 1750 are pre-defined in the method 1700. Each coding mode includes: a pre-defined pattern of a plurality of pre-defined patterns of the node pixels 241; and encoding parameters for encoding the node and the cell pixels 241 and 242, respectively.

In a step 1701, the image 200 is divided into macro-blocks 201 . . . 212. In a step 1702, node/cell pixel structure is defined in the first macro-block 201 according to a selected one of the plurality of the coding modes 1750. In a step 1703, the node pixels 241 are encoded according to the coding mode selected. In a step 1704, the cell pixels 242 are interpolated according to the coding mode selected. In a step 1705, residuals of the macro-block 201 are encoded. The residuals are computed by computing a difference 1706 between the actual and previously encoded values of pixels of the macro-block 201. The residuals computing step 1706 is optional, depending on the coding mode selected. In a step 1707, a rate-distortion parameter is calculated. The rate-distortion parameter is a weighted sum of a bitrate required for transmission of the macro-block 201, proportional to number of bits/bytes of the encoded macro-block 201, and a distortion parameter, proportional to an average deviation between actual and encoded pixel values:

C=D+λ·R

wherein D is the distortion represented by the Peak Signal-to-Noise Ratio (PSNR) or Mean Square Error (MSE) between the encoded image and the original image; R is the rate that represents the bit usage of the encoding; λ is a Lagrangian multiplier that determines how the rate and distortion is weighted into the rate-distortion parameter calculation. Generally, the parameter C can be based on differences between original and reconstructed values of pixels of the first macro-block 201, and on a value for a number of bits needed to encode the pixels of the first macro-block.

The steps 1702 to 1707 are repeated for each of the plurality of the coding modes 1750 and preferably for each remaining macro-block 202 . . . 212. Upon repeating the steps 1702 to 1707 for each of the plurality of the coding modes 1750, an “optimal” coding mode is selected in a step 1708. The optimal coding mode corresponds to the lowest of the rate-distortion parameters C of the macro-block 201, calculated in step 1707. Steps 1702 . . . 1708 are repeated for each block 201 . . . 212 of the image 200. Steps 1701 . . . 1704 of the method 1700 of FIG. 17 correspond to steps 251 . . . 253 and 255, respectively, of the method 250 of FIG. 2B.

In a preferred implementation of the invention, the following seven coding modes are defined for 32×32 pixel macro-blocks:

Mode 1: plane fitting prediction

Mode 2: 4×4 node pixels without residual coding

Mode 3: 8×8 node pixels without residual coding

Mode 4: 16×16 node pixels without residual coding

Mode 5: 4×4 node pixels with residual coding

Mode 6: 8×8 node pixels with residual coding

Mode 7: 16×16 node pixels with residual coding

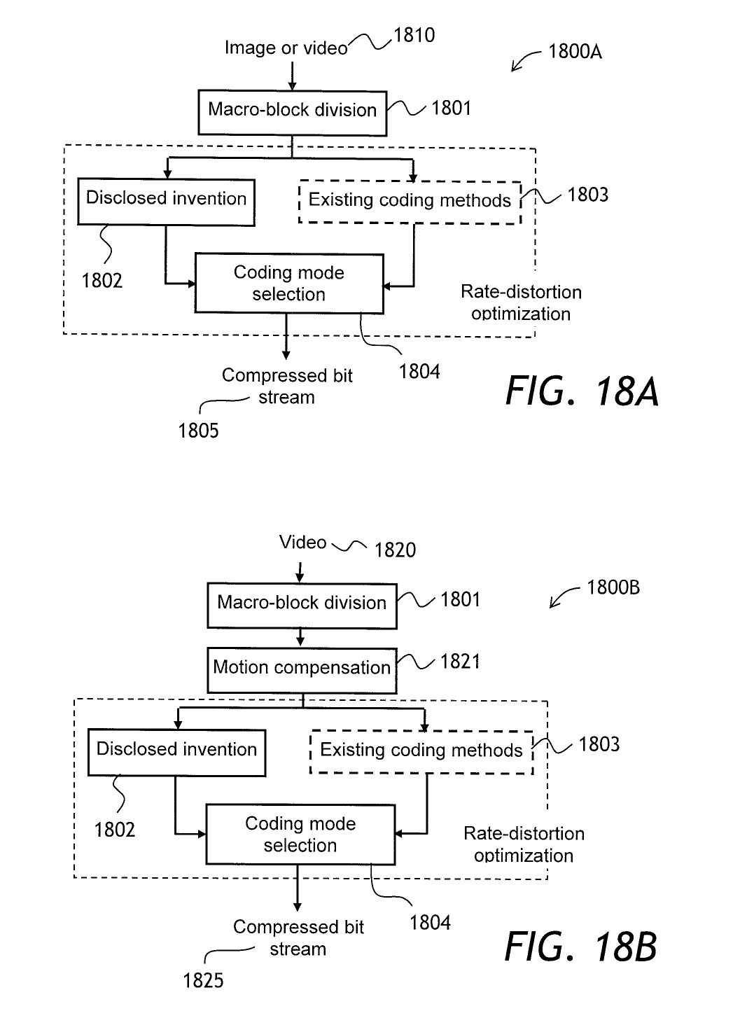

The first coding mode uses plane fitting to predict pixels in a current macro-block. The neighboring macro-blocks located above and to the left of the current macro-block are already coded, and the pixels in those macro-blocks are available for the plane fitting calculation. This mode is efficient for regions without much texture or detail. It can be considered as the mode with zero node pixels. Coding modes 2 to 7 differ by the density of node pixels and choice of residual coding. There is the trade-off between bit usage for node pixels and cell residuals, which affects the distortion of the encoded macro-blocks. The above described method 1700 allows one to take advantage of the trade-off. In one embodiment, coding modes of the invention are combined with, or integrated into, existing coding modes and methods. Referring now to FIG. 18A, a process 1800A of intra-coding of an image or a video frame 1810 is presented. The process 1800A includes existing coding modes and methods, for example MPEG-4 AVC or JPEG-2000 coding modes and methods, into an overall rate-distortion optimization process. In a step 1801, the image or video 1810 is divided into macro-blocks. In a step 1802, one of the macro-blocks (a “first” macro-block) is encoded using node-cell pixel division and encoding methods disclosed in the invention. In a parallel step 1803, the first macro-block is encoded using existing coding methods. In a step 1804, the rate-distortion parameters for each mode are compared, to select a coding mode or method corresponding to the minimal rate-distortion parameter. Existing encoding modes/methods can be selected for some of the macro-blocks. The selected coding mode is used to encode the first macro-block, providing a compressed bit stream 1805. The steps 1801 . . . 1804 of the process 1800A are repeated for the remaining macro-blocks. The coding modes or methods providing the best rate-distortion optimization are selected on block-by-block basis.

In another embodiment, coding modes of the invention are integrated into a video inter-frame coding process. Referring now to FIG. 18B, a process 1800B of inter-frame coding of a video 1820 is presented. The process 1800B is similar to the process 1800A of FIG. 18A, the difference being that frames of a video 1820 divided into the macro-blocks in the step 1801 are motion-compensated residuals in a step 1821. After motion estimation and motion compensation, the residuals, as measured between the motion compensated pixels and original values of pixels, are encoded as described above, to provide a compressed video bit stream 1825.

A coding method of the invention was implemented to build a coding system of the method 1800A of FIG. 18A following the coding path from the step 1801 to the step 1802, then to the step 1804, without using the step 1803. The coding method uses the seven coding modes, Mode 1 . . . Mode 7, defined above. Experiments have been performed to estimate the coding efficiency of the invention, as compared to MPEG-4 AVC (H.264) encoding including High profile, intra-only encoding with 30 fps, and CABAC entropy encoding. Only luminance components of the high-definition video frames have been encoded and decoded.

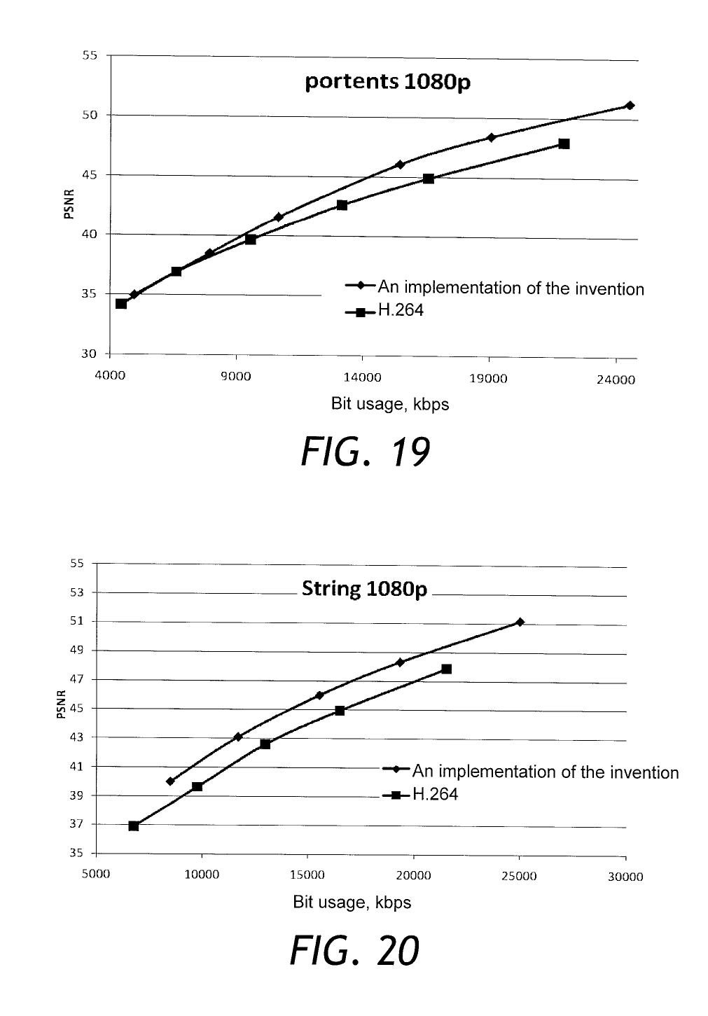

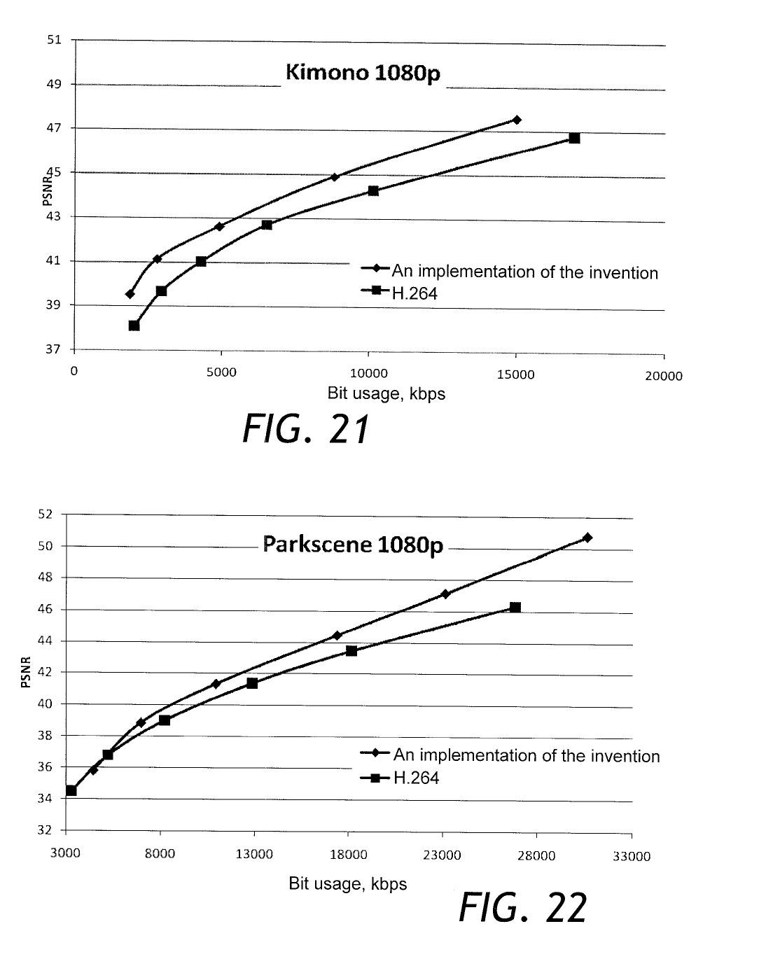

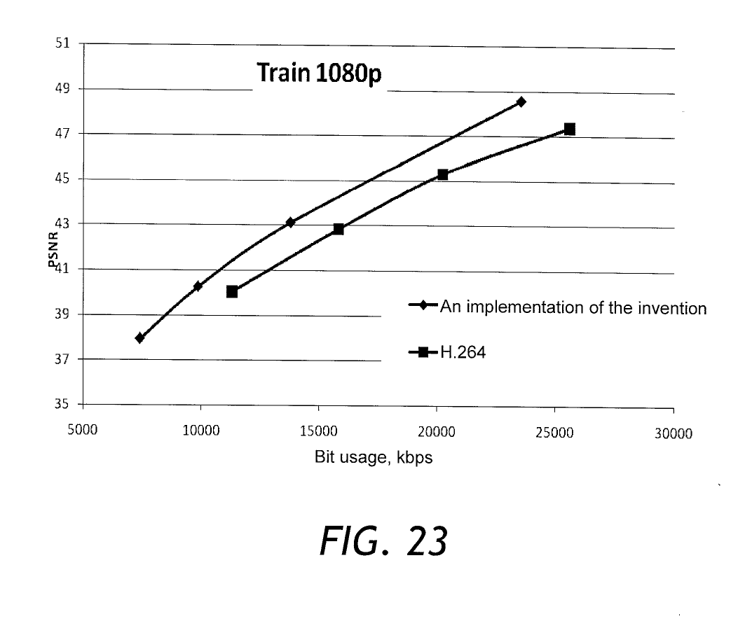

The video test sequences included 1080p videos from JVT and HEVC test sequences. Referring now to FIGS. 19 to 23, PNSR (in dB) is plotted as a function of bit usage (in kilobits per second) for Portents, String, Kimono, Parkscene, and Trains standard test sequences, respectively. It can be seen that the disclosed invention provides significant rate-distortion performance gain. The coding gain for the sequence Parkscene is up to 2.4 dB. The average coding gain for all five sequences over a wide bit rate range is about 1 dB.

Table I shows a percentage of different modes selected for these test sequences when quantization parameter for encoding is set to 30. The percentage of coding mode selection and rate distortion performance plots in FIGS. 19 to 23 prove efficiency of the invention for high-definition television (HDTV) video storage and transmission.

TABLE 1

| Mode | Portent | String | Kimono | Parkscene | Train |
|---|---|---|---|---|---|
| Mode 1 | 1.5% | 0.1% | 0% | 1% | 0% |
| Mode 2 | 3.9% | 0.8% | 1.3% | 9.4% | 3% |
| Mode 3 | 6.8% | 3.5% | 3.5% | 10.4% | 7% |
| Mode 4 | 10.6% | 8% | 10.8% | 8.3% | 12% |
| Mode 5 | 54.5% | 58% | 68% | 38.6% | 53.1% |
| Mode 6 | 21.9% | 29.5% | 15.1% | 31.2% | 23.5% |
| Mode 7 | 0.75% | 0.1% | 0.3% | 0.9% | 1.3% |

The methods/processes 250, 400, 800, 1000, 1500, 1700, 1800A, 1800B of the invention can be implemented in software or hardware including ASIC, microprocessor, FPGA, and the like. By way of example, a system embodying the method 250 of FIG. 2B for encoding the image 200 of FIG. 2A can include a unit suitably configured for defining in the image 200 a plurality of macro-blocks of pixels 201 . . . 212, for subsequent block-by-block encoding; and a macro-block processor suitably configured for encoding at least a first macro-block of the plurality of macro-blocks using the method 200. Preferably, the system includes a store of coding modes operationally coupled to the macro-block processor, each coding mode including: a pre-defined pattern of a plurality of pre-defined patterns of the node pixels; and encoding parameters for encoding the node and the cell pixels. A computer readable storage medium can be used to store thereon a set of CPU commands for executing methods/processes 250, 400, 800, 1000, 1500, 1700, 1800A, 1800B of the invention.

The foregoing description of one or more embodiments of the invention has been presented for the purposes of illustration and description. It is not intended to be exhaustive or to limit the invention to the precise form disclosed. The term “image” should not be understood as encompassing still images only. As is evident from the foregoing description, the term “image” can include a video frame or an array of residuals of motion compensation. By way of another example, “pixel values” can include luminance, color coordinates, individual luminances of primary colors, and the like.

It will be appreciated by those skilled in the art that block diagrams herein can represent conceptual views of illustrative circuitry embodying the principles of the technology. Similarly, it will be appreciated that any flow charts and diagrams represent various processes which may be substantially implemented in hardware, software, or both. When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

It is generally intended that the scope of the invention be limited not by this detailed description, but rather by the claims appended hereto.

What is claimed is:

1. A method for encoding an image, implemented at least in part by a computing device, the method comprising:
(a) defining in the image a plurality of macro-blocks of pixels, for subsequent block-by-block encoding; and
(b) for at least a first macro-block of the plurality of macro-blocks of step (a),
(i) defining a portion of pixels of the first macro-block as node pixels, and defining the remaining pixels of the first macro-block as cell pixels, wherein the node pixels are disposed in a pre-defined pattern of pixels;
(ii) encoding values of the node pixels of the first macro-block as node pixel information;
(iii) reconstructing the values of the node pixels from the node pixel information of step (b)(ii); and
(iv) encoding values of the cell pixels of the first macro-block as cell pixel information, using the reconstructed values of step (b)(iii).

2. The method of claim 1, wherein in step (b)(i), the node pixels are non-adjacent to each other.

3. The method of claim 2, wherein in step (b)(i), the node pixels are unevenly spaced from each other.

4. The method of claim 1, wherein step (b) is repeated for a second macro-block of the plurality of macro-blocks of step (a), wherein node pixel patterns of the first and second macro-blocks differ from each other.

5. The method of claim 1, wherein in step (b)(i), the node pixels comprise a 2M×2N rectangular array of pixels, wherein M and N are integers≧2, wherein the 2M×2N rectangular array of pixels includes first and second M×N interleaved rectangular sub-arrays of node pixels, wherein node pixels of any row of the first sub-array are interleaved with node pixels of a corresponding row of the second sub-array; and wherein step (b)(ii) further includes
(A) encoding values of the node pixels of the first sub-array as first sub-array node pixel information;
(B) reconstructing the values of the node pixels of the first sub-array from the first sub-array node pixel information of step (A); and
(C) encoding values of the node pixels of the second sub-array as second sub-array node pixel information, using the reconstructed values of step (B).

6. The method of claim 5, wherein in step (b)(i), the 2M×2N rectangular array of pixels further includes third and fourth M×N interleaved rectangular sub-arrays of node pixels,
wherein node pixels of any column of the third sub-array are interleaved with node pixels of a corresponding column of the first sub-array;
wherein node pixels of any row of the fourth sub-array are interleaved with node pixels of a corresponding row of the third sub-array;
wherein node pixels of any column of the fourth sub-array are interleaved with node pixels of a corresponding column of the second sub-array; and wherein step (b)(ii) further includes
(D) encoding values of the node pixels of the third sub-array as third sub-array node pixel information, using the reconstructed values of step (B); and at least one of the following steps (E1), (E2), and (E3):
(E1) encoding the node pixels of the fourth sub-array as fourth sub-array node pixel information, using the reconstructed values of step (B);
(E2) reconstructing the values of the node pixels of the second sub-array from the second sub-array node pixel information of step (C), followed by encoding the node pixels of the fourth sub-array as the fourth sub-array node pixel information, using the reconstructed values of this step, or
(E3) reconstructing the values of the node pixels of the third sub-array from the third sub-array node pixel information of step (D), followed by encoding the node pixels of the fourth sub-array as the fourth sub-array node pixel information, using the reconstructed values of this step.

7. The method of claim 6, wherein step (A) includes
(A1) intra-predicting the values of the node pixels of the first sub-array; and
(A2) DCT-encoding residuals of the intra-predicted node pixel values of step (A1);
wherein step (C) includes
(C1) interpolating the values of the node pixels of the second sub-array using the reconstructed values of step (B); and
(C2) DCT-encoding residuals of the interpolated node pixel values of step (C1);
wherein step (D) includes
(D1) interpolating values of the node pixels of the third sub-array using the reconstructed values of step (B); and
(D2) DCT-encoding residuals of the interpolated node pixel values of step (D1); and
wherein the encoding in steps (E1), (E2), and (E3) includes interpolating values of the node pixels of the fourth sub-array using the reconstructed values of steps (E1), (E2), and (E3), respectively, followed by DCT-encoding of residuals of the respective interpolated node pixel values.

8. The method of claim 1, wherein step (b)(ii) includes:
(F) prediction- or interpolation-coding the values of the node pixels of the first macro-block; and
(G) spatial-transform coding of residuals of the prediction or interpolation coding of step (F).

9. The method of claim 8, wherein step (b)(ii) further includes
(H) quantizing the spatial-transform coded residuals of step (G); and wherein step (b)(iv) includes:
(I) interpolating values of the cell pixels of the first macro-block using the reconstructed values of the node pixels of step (b)(iii);
(J) spatial-transform coding of residuals of the interpolation of step (I); and
(K) quantizing the spatial-transform coded residuals of step (J);
wherein a quantization parameter Q_{N} of step (G) is equal to or smaller than a quantization parameter Q_{C} of step (J).

10. The method of claim 9, wherein
Q_{C}=αQ_{N}²+βQ_{N}+γ, wherein α, β, and γ are pre-defined parameters.

11. The method of claim 8, wherein the spatial-transform coding of step (G) comprises DCT encoding; and wherein step (b)(iv) includes:
(L) interpolating values of the cell pixels of the first macro-block using the reconstructed values of the node pixels of step (b)(iii);
(M1) computing residuals of the interpolation of step (L) for even and odd rows of the cell pixels of the first macro-block;
(M2) one-dimensional DCT-encoding of residuals for the even rows of the cell pixels of the first macro-block;
(M3) one-dimensional DCT encoding of residuals for the odd rows of the cell pixels of the first macro-block;
and, upon completion of steps (M2) and (M3),
(M4) one-dimensional DCT encoding of DCT-transformed residuals of steps (M2) and (M3) for the even columns of the cell pixels of the first macro-block; and
(M5) one-dimensional DCT encoding of DCT-transformed residuals of steps (M2) and (M3) for the odd columns of the cell pixels of the first macro-block;
wherein the one-dimensional DCT encodings of steps (M2) and (M3) are of different lengths; and
wherein the one-dimensional DCT encodings of steps (M4) and (M5) are of different lengths.

12. The method of claim 1, wherein first, second, third, and fourth neighboring node pixels of the plurality of node pixels of the first macro-block of step (b) are disposed in four consecutive corners of a rectangle defining a sub-block of pixels comprising cell pixels and the fourth node pixel, and wherein step (b)(iv) comprises:
(N) fitting values of the first, second, third, and fourth node pixels with a bilinear function, so as to determine a set of fitting coefficients; and
(O) performing a bilinear interpolation of values of the cell pixels of the sub-block using the set of the bilinear function fitting coefficients of step (N).

13. The method of claim 12, wherein step (O) further includes:
(O1) performing a linear interpolation of values of first and second boundary cell pixels disposed between the first and the second; and the second and the third node pixels, respectively;
(O2) computing residuals of the linear interpolation of the values of the first and second boundary cell pixels; and
(O3) directionally propagating the residuals of the boundary cell pixel values computed in step (O2) into the cell pixels of the sub-block.

14. The method of claim 13, wherein a fifth node pixel of the plurality of node pixels of the first macro-block of step (b) is disposed in a same row of pixels as the second and the third node pixels, next to the third node pixel;
wherein step (N) includes fitting the values of the first, second, third, and fifth node pixels with a linear function;
wherein step (O1) further includes performing a linear interpolation of values of third boundary cell pixels disposed between the third and the fifth node pixels; and
wherein step (O2) further includes computing residuals of the linear interpolation of the values of third boundary cell pixels.

15. The method of claim 6, wherein M=N=4.

16. The method of claim 6, wherein M=N=2.

17. The method of claim 16, wherein step (b)(iv) further comprises
(P) interpolating values of the cell pixels using the reconstructed values of the node pixels; and
(Q) DCT-encoding residuals of the interpolated cell pixel values of step (P).

18. The method of claim 1, wherein step (b) is repeated at a plurality of coding modes, each coding mode of the plurality of coding modes including: a pre-defined pattern of a plurality of pre-defined patterns of the node pixels; and encoding parameters for encoding the node and the cell pixels,
wherein step (b) further comprises
(v) calculating a rate-distortion parameter of the first macro-block, based on differences between original and reconstructed values of pixels of the first macro-block, and on a value for a number of bits needed to encode the pixels of the first macro-block;
wherein the method further comprises
(c) upon repeating step (b) for each of the plurality of coding modes, selecting a first coding mode out of the plurality of coding modes, wherein the first coding mode corresponds to the lowest of the rate-distortion parameters of the first macro-block, calculated in step (v).

19. The method of claim 1, wherein step (b) further comprises
(v) calculating a first rate-distortion parameter of the first macro-block, based on residuals of encoding of the pixels of the first macro-block, and on a value for a number of bits needed to encode the pixels of the first macro-block;
wherein the method further comprises
(d) encoding the pixels of the first macro-block using a MPEG-4 AVC or JPEG-2000 coding mode;
(e) calculating a second rate-distortion parameter of the first macro-block encoded in step (d), based on residuals of encoding of the pixels of the first macro-block, and on a value for a number of bits needed to encode the pixels of the first macro-block; and
(f) comparing the first and second rate-distortion parameters, for selecting an encoding corresponding to the lower of the first and second rate-distortion parameters.

20. A method for encoding and decoding an image comprising a two-dimensional array of pixels, the method comprising:
encoding the image according to the method of claim 1;
storing the encoded image on a digital storage medium, or transmitting the encoded image to a destination; and
decoding the encoded image that has been read out from the digital storage medium or received at the destination, respectively, the decoding comprising:
for at least the first macro-block, reconstructing the values of the node pixels of the first macro-block from the node pixel information of step (b)(ii); and reconstructing the values of the cell pixels of the first macro-block using the reconstructed values of the node pixels of the first macro-block.

21. Use of the method of claim 20 for a video storage or transmission.

22. A computer readable non-transitory storage medium having encoded thereon a set of CPU commands for performing the method of claim 1.

23. A system for compressing an image, comprising:
a unit suitably configured for defining in the image a plurality of macro-blocks of pixels, for subsequent block-by-block encoding; and
a macro-block processor suitably configured for encoding at least a first macro-block of the plurality of macro-blocks by
(i) defining a portion of pixels of the first macro-block as node pixels, and defining the remaining pixels of the first macro-block as cell pixels, wherein the node pixels are disposed in a pre-defined pattern of pixels;
(ii) encoding values of the node pixels of the first macro-block as node pixel information;
(iii) reconstructing the values of the node pixels from the node pixel information; and
(iv) encoding values of the cell pixels of the first macro-block as cell pixel information, using the reconstructed values of the node pixels.

24. The system of claim 23, further comprising a store of coding modes operationally coupled to the macro-block processor, each coding mode including: a pre-defined pattern of a plurality of pre-defined patterns of the node pixels; and encoding parameters for encoding the node and the cell pixels.
